(19) United States
(12) Patent Application Publication
(10) Pub. No.: US 2018/0006315 A1
(43) Pub. Date: Jan. 4, 2018

(54) POROUS ADHESIVE NETWORKS IN ELECTROCHEMICAL DEVICES

(71) Applicant: 3M INNOVATIVE PROPERTIES COMPANY, St Paul, MN (US)

(72) Inventors: Daniel M. Pierpont, St. Paul, MN (US); Michael A. Yandrasits, Hastings, MN (US); Joseph W. Frisk, Oakdale, MN (US)

(21) Appl. No.: 15/536,401

(22) PCT Filed: Dec. 15, 2015
(86) PCT No.: PCT/US2015/065742

§ 371 Date: Jun. 15, 2017

Related U.S. Application Data
(60) Provisional application No. 62/096,638, filed on Dec. 24, 2014.

(51) Int. Cl. H01M 8/0297; H01M 8/18; C25B 1/10; C25B 11/03; C25B 9/10; C25B 15/08; H01M 8/1004; H01M 8/1018

(52) U.S. Cl. CPC H01M 8/0297; C25B 15/08; H01M 8/188; H01M 8/1004; C25B 1/10; C25B 11/035; C25B 9/10; H01M 2008/1095

(57) ABSTRACT

An article comprising a first gas distribution layer (100), a first gas dispersion layer (200), or a first electrode layer, having first and second opposed major surfaces and a first adhesive layer having first and second opposed major surfaces, wherein the second major surface (102) of the first gas distribution layer (100), the second major surface (202) of the first gas dispersion layer (200), or the first major surface of the first electrode layer, as applicable, has a central area, wherein the first major surface of the first adhesive layer contacts at least the central area of the second major surface of the first gas distribution layer, the second major surface of the first gas dispersion layer, or the first major surface of the first electrode layer, as applicable, and wherein the first adhesive layer comprises a porous network of first adhesive including a continuous pore network extending between the first and second major surfaces of the first adhesive layer. The articles described herein are useful, for example, in membrane electrode assemblies, unitized electrode assemblies, and electrochemical devices (e.g., fuel cells, redox flow batteries, and electrolyzers).

### CROSS REFERENCE TO RELATED APPLICATION

This application claims the benefit of U.S. Provisional Patent Application No. 62/096,638, filed Dec. 24, 2014, the disclosure of which is incorporated by reference herein in its entirety.

### BACKGROUND

In certain electrochemical devices, such as polymer electrolyte membrane fuel cells, an electrocatalyst material such as supported or unsupported platinum nanoparticles is coated on or attached to at least one side of the polymer electrolyte membrane. Electrical current may be conducted to and from the electrocatalyst material by means of an adjacent, electrically conductive and porous gas distribution layer, which is often a carbon paper, carbon felt, or carbon cloth material. The conductive gas distribution layer should maintain good physical and electrical contact with the electrochemically active area of the catalyst coated membrane. This is often accomplished in part by compressing the various cell components together when assembling the cell. In addition, the gas distribution layers and catalyst coated membrane can be adhesively bonded together outside of the catalyst active area. However, as a result of differences in the thermal expansion coefficients of the gas distribution layer and the catalyst coated membrane, as well as variations in the degree of swelling of the hydrophilic catalyst coated membrane with variations in cell temperature and degree of hydration, the catalyst coated membrane and gas distribution layer can separate or “pillow.” It would be desirable to provide additional “anchoring” of the gas distribution layers to the catalyst coated membrane in the active area, to maintain electrical contact and to allow the combination to be handled as a single unit during cell assembly. However, such anchoring attachment points should not significantly block portions of the active area, or otherwise diminish the performance of the electrochemical cell (see, e.g., U.S. Pat. No. 7,147,959, Köhler et al.).

### SUMMARY

In one aspect, the present disclosure describes an article comprising a first gas distribution layer, a first gas dispersion layer, or a first electrode layer having first and second opposed major surfaces and a first adhesive layer having first and second opposed major surfaces, wherein the second major surface of the first gas distribution layer, the first major surface of the first adhesive layer contacts at least the central area of the second major surface of the first gas dispersion layer, or the second major surface of the first adhesive layer contacts at least the central area of the first major surface of the first electrode layer, as applicable, has a central area, wherein the first major surface of the first adhesive layer contacts at least the central area of the second major surface of the first gas distribution layer, the second major surface of the first gas dispersion layer, or the first major surface of the first electrode layer, as applicable, and wherein the first adhesive layer comprises a porous network of first adhesive including a continuous pore network extending between the first and second major surfaces of the first adhesive layer. In some embodiments, there is one or more additional adhesive layers with the first major surface of the applicable adhesive layer contacting at least the central area of the second major surface of the first gas distribution layer, the second major surface of the first gas dispersion layer, or the first major surface of the first electrode layer, as applicable.

Articles described herein are useful, for example, in membrane electrode assemblies, unitized electrode assemblies, and electrochemical devices (e.g., fuel cells, redox flow batteries, and electrolyzers). Membrane electrode assemblies are used to make electrochemical devices such as fuel cells and electrolyzers. Unitized electrode assemblies are used to make electrochemical devices such redox flow batteries.

### BRIEF DESCRIPTION OF THE DRAWINGS

FIG. 1 is an exploded schematic of an exemplary article described herein.

FIG. 2A is an exploded schematic of an exemplary embodiment of a fuel cell having a membrane electrode assembly described herein that includes the article shown in FIG. 1.

FIG. 2B is a perspective view of a portion of the first adhesive layer shown in FIGS. 1 and 2A.

FIG. 3A is a schematic of exemplary embodiments of membrane electrode assemblies described herein.

FIG. 3B is a schematic of an exemplary embodiment of a fuel cell having an exemplary membrane electrode assembly described herein.

FIG. 4 is a schematic of an exemplary embodiment of an electrolyzer having a membrane electrode assembly described herein.

FIG. 5A is a scanning electron microscope (SEM) surface image at 500x of a porous adhesive layer in Example 5.

FIG. 5B is a scanning electron microscope (SEM) surface image at 1700× of a porous adhesive layer in Example 5.

FIG. 6 is a schematic view of a device for electrospinning nanofibers onto a substrate.

FIG. 7 is a chart showing 180 degree peel strengths measured according to ASTM D3330 for nanofiber-adhesive-coated gas diffusion layers prepared as in Examples 1-3 that have been bonded to a catalyst coated membranes.

FIG. 8 is a plot showing a galvano-dynamic scanning (GDS) polarization performance comparison between membrane electrode assemblies having electrospun gas diffusion layer adhesive (with and without high temperature bonding) and an unbonded control sample.

FIG. 9 is a plot comparing the high frequency resistance of membrane electrode assemblies containing an electrospun gas diffusion layer adhesive (with and without high temperature bonding) to an unbonded control sample.

FIG. 10 is a plot comparing the sensitivity to reduction in cathode air stoichiometry of membrane electrode assemblies containing electrospun gas diffusion layer adhesive (with and without bonding) to the sensitivity of an unbonded control sample.

### DETAILED DESCRIPTION

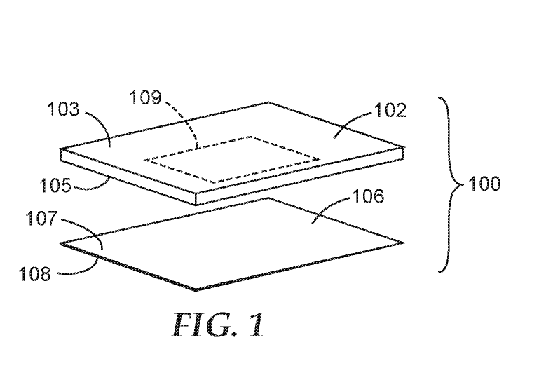

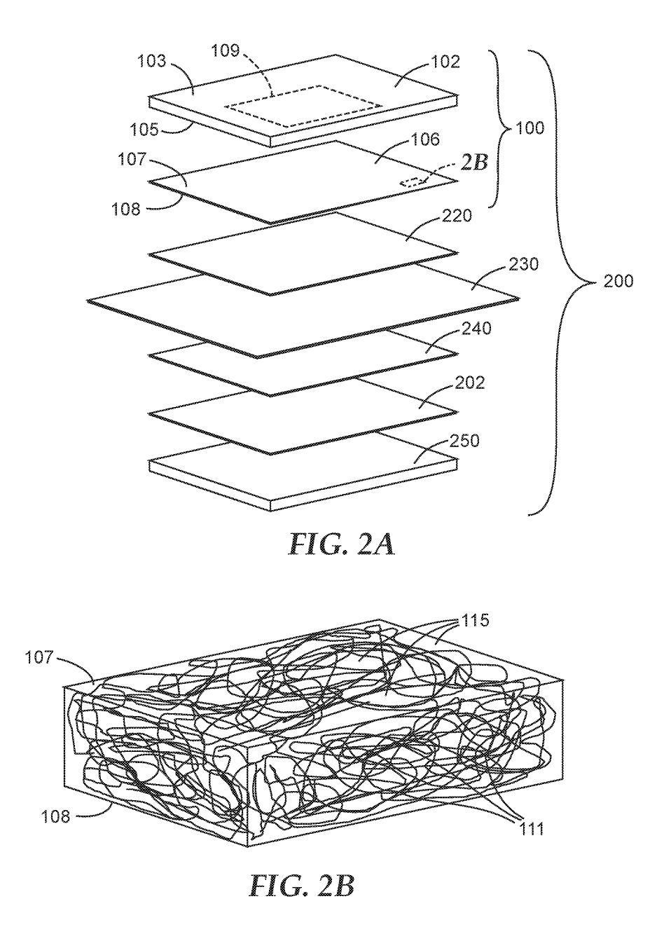

Referring to FIGS. 1 and 2B, article 100 has first gas distribution layer 102 with first and second opposed major surfaces 103, 105 and first adhesive layer 106 with first and second opposed major surfaces 107, 108. Second major surface 105 of first gas distribution layer 102 has central area 109. First major surface 107 of first adhesive layer 106 contacts at least central area 109 of second major surface 105 of first gas distribution layer 102. First adhesive layer 106 comprises porous network 111 of adhesive including continuous pore network 115 extending between first and second major surfaces 107, 108 of first adhesive layer 106. In addition, or alternatively, an adhesive layer like adhesive layer 106 could contact a central area of a gas dispersion layer and/or an electrode (e.g., anode catalyst or cathode catalyst) layer.

In some embodiments, the article having a first adhesive layer contacting at least a central area of the second major surface of a gas distribution layer further comprises a first catalyst layer having first and second opposed major surfaces, wherein the second major surface of the first adhesive layer contacts the first major surface of the first catalyst layer. In some embodiments, the article having a first adhesive layer contacting at least a central area of the second major surface of a gas distribution layer further comprises a first gas dispersion layer having first and second opposed major surfaces, and a first catalyst layer having first and second opposed major surfaces, wherein the second major surface of the first adhesive layer contacts the first major surface of the first gas dispersion layer, and wherein the layers in order are the first gas distribution layer, the first adhesive layer, the first gas dispersion layer, and the first catalyst layer.

Exemplary adhesives comprise fluorinated thermoplastics (e.g., polyvinylidene fluoride (PVDF) or poly(tetrafluoroethylene-co-vinylidene fluoride-co-hexafluoropropylene,) (available, for example, under the trade designation “THV 220” from 3M Company, St. Paul, Minn.) and hydrocarbon thermoplastics (e.g., acrylate and rubber, styrene)).

In some embodiments, the porous network of the first adhesive comprises a plurality of first elongated adhesive elements (e.g., fibers). In some embodiments, the first elongated adhesive elements have an aspect ratio of at least 10:1 (in some embodiments, an aspect ratio of at least 100:1 to 1000:1, or even at least 10000:1). In some embodiments, the first elongated adhesive elements have lengths of at least 10 micrometers (in some embodiments, at least 25 micrometers, 100 micrometers, or even at least 1 centimeter) and at least one of diameters or widths in a range from 50 nm to 10000 nm (in some embodiments, in the range from 100 nm to 2000 nm, 200 nm to 1000 nm, or even 300 nm to 500 nm).

In some embodiments, an adhesive layer has porosity of at least 50 percent (in some embodiments, at least 55, 60, 65, 70, 75, 80, 90 percent or even at least 95 percent; in some embodiments, in the range from 50 to 90, 60 to 80, or even 60 to 75), based on the total volume of the adhesive layer (i.e., the total pore volume and solid volume of the adhesive layer). In some embodiments, the adhesive layer has a thickness up to 10 micrometers (in some embodiments, up to 9 micrometers, 8 micrometers, 7 micrometers, 6 micrometers, 5 micrometers, 4 micrometers, 3 micrometers, 2 micrometers, or even up to 1 micrometer; in some embodiments, in a range from 0.5 micrometer to 10 micrometers, 0.5 micrometer to 5 micrometers, or even 0.5 micrometer to 2 micrometers).

The adhesive layer can be provided, for example, by:
providing a first gas distribution layer, a first gas dispersion layer, or a first electrode layer, as applicable, having first and second opposed major surfaces, wherein the first and second major surfaces of the first gas distribution layer, the first gas dispersion layer, or the first electrode layer, as applicable, each have an active area;
providing an adhesive composition; and
at least one of electrospinning or electrospraying the adhesive composition onto at least the active area of the second major surface of the first gas distribution layer, of the second major surface of the first gas dispersion layer, or of the first major surface of the first electrode layer, as applicable, to provide the adhesive layer.

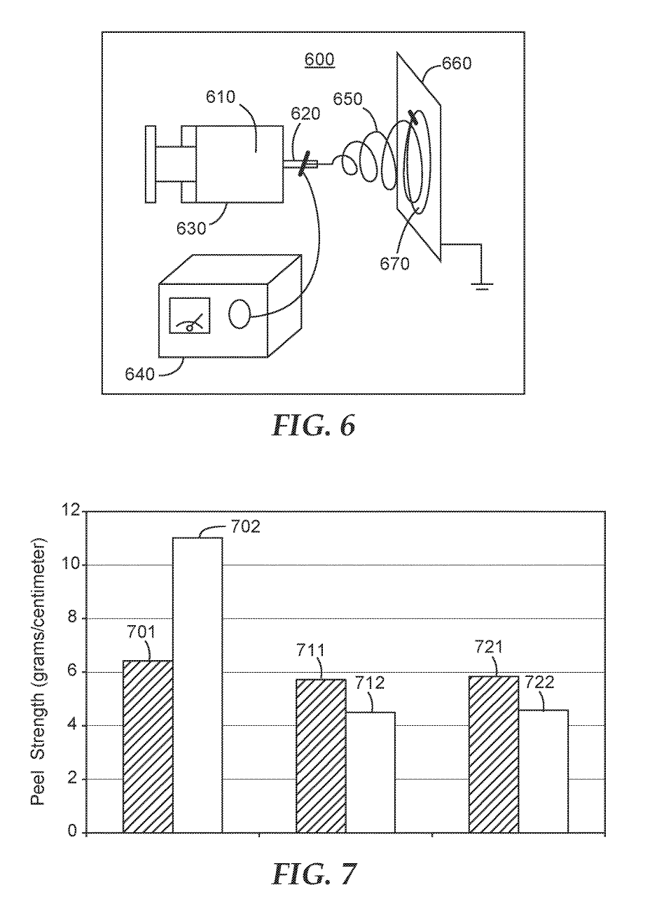

Processes producing polymer nanofibers via electrostatic spinning or “electrospinning” are known in the art, and include those described, for example, in “Electrospinning of Nanofibers: Reinventing the Wheel?”, D. Li and Y. Xia, Advanced Materials, Volume 16, Issue 14, pages 1151-1170, July 2004. An exemplary electrospinning apparatus 600 is shown in FIG. 6. The process in general involves forcing a polymer solution or melt through a small-bore metal tube (such as syringe needle 620 of syringe 630) that is held at a high electrical potential via a high voltage generator, 640. As the polymer solution is extruded and the solvent evaporates or the polymer melt cools, there is formed a polymer filament 650 that is collected on a grounded target substrate or collector 660. The collected electrospun nanofiber filaments 650 form a porous nonwoven fabric 670 on the target substrate 660.

An exemplary article (e.g., a membrane electrode assembly or a unitized electrode assembly) comprises, in order:
a first gas distribution layer having first and second opposed major surfaces;
optionally a first gas dispersion layer having first and second opposed major surfaces;
an anode catalyst layer having first and second opposed major surface, the anode catalyst comprising first catalyst;
a membrane;
a cathode catalyst layer having first and second opposed major surfaces, the cathode catalyst comprising a second catalyst;
optionally a second gas dispersion layer having first and second opposed major surfaces; and
a second gas distribution layer having first and second opposed major surfaces, wherein at least one of (i.e., any one or any combinations):

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the second major surface of the first gas distribution layer has a central area, wherein the first major surface of the adhesive layer contacts at least the central area of the second major surface of the first gas distribution layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the second major surface of the first gas dispersion layer has a central area, wherein the first major surface of the adhesive layer contacts at least the central area of the second major surface of the first gas distribution layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the first major surface of the anode catalyst layer has a central area, wherein the second major surface of the adhesive layer contacts at least the central area of the first major surface of the anode catalyst layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the second major surface of the cathode catalyst layer has a central area, wherein the first major surface of the adhesive layer contacts at least the central area of the second major surface of the cathode catalyst layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the first major surface of the second gas dispersion layer has a central area, wherein the second major surface of the adhesive layer contacts at least the central area of the first major surface of the second gas dispersion layer; or

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the first major surface of the second gas distribution layer has a central area, wherein the second major surface of the adhesive layer contacts at least the central area of the first major surface of the second gas distribution layer. For example, referring to FIG. 2, exemplary membrane electrode assembly 200 has article 100 (see FIG. 1), catalyst layer 220 (e.g., an anode catalyst layer), membrane 230, a second catalyst layer 240 (e.g., a cathode catalyst layer), optional second adhesive layer 202, and second gas distribution layer 250.

A gas distribution layer generally delivers gas evenly to the electrodes and in some embodiments conducts electricity. It also provides removal of water in either vapor or liquid form, in the case of a fuel cell. An exemplary gas distribution layer is a gas diffusion layer, also sometimes referred to as a macro-porous gas diffusion backing (GDB). Sources of gas distribution layers include carbon fibers randomly oriented to form porous layers, in the form of non-woven paper or woven fabrics. The non-woven carbon papers are available, for example, from Mitsubishi Rayon Co., Ltd., Tokyo, Japan, under the trade designation “GRAFIL U-105;” Toray Corp., Tokyo, Japan, under the trade designation “TORAY;” AvCarb Material Solutions, Lowell, Mass., under the trade designation “AVCARB;” SGL Group, the Carbon Company, Wiesbaden, Germany, under trade designation “SIGRACET;” Freudenberg FCCT SE & Co. KG, Fuel Cell Component Technologies, Weinheim, Germany, under trade designation “FREUDENBERG;” and Engineered Fibers Technology (EFT), Shelton, Conn., under trade designation “SPECTRACARB GDL.” The woven carbon fabrics or cloths are available, for example, from ElectroChem Inc., Woburn, Mass., under the trade designations “EC-CC1-060” and “EC-AC-CLOTH;” NuVant Systems Inc., Crown Point, Ind., under the trade designations “ELAT-LT” and “ELAT;” BASF Fuel Cell GmbH, North America, under the trade designation “E-TEK ELAT LT;” and Zoltek Corp., St. Louis, Mo., under the trade designation “ZOLTEK CARBON CLOTH.”

In some embodiments, carbon-supported catalyst particles are used. Typical carbon-supported catalyst particles are present in a range from 50 to 90 wt. % carbon and catalyst metal in a range from 50 to 10 wt. %, wherein for fuel cells the catalyst metal typically comprises Pt for the cathode and Pt or Pt and Ru in a weight ratio of about 2:1 for the anode. Typically, the catalyst is applied to the polymer electrolyte membrane or to the gas diffusion layer in the form of a catalyst ink. Alternately, for example, the catalyst ink may be applied to a transfer substrate, dried, and thereafter applied to the polymer electrolyte membrane or to the gas diffusion layer as a decal. The catalyst ink typically comprises polymer electrolyte material, which may or may not be the same polymer electrolyte material which comprises the polymer electrolyte membrane. The catalyst ink typically comprises a dispersion of catalyst particles in a dispersion of the polymer electrolyte. The ink typically contains in a range from 5 to 30 wt. % solids (i.e., polymer and catalyst) and more typically in a range from 10 to 20 wt. % solids. The electrolyte dispersion is typically an aqueous dispersion, which may additionally contain alcohols and polyalcohols (e.g., glycerin and ethylene glycol). The water, alcohol, and polyalcohol content may be adjusted to alter rheological properties of the ink. In some embodiments, the ink typically contains in a range from 0 to 50 wt. % alcohol and in a range from 0 to 20 wt. % polyalcohol. In some embodiments, the ink may contain in a range from 0 to 2 wt. % of a suitable dispersant. The ink can be made, for example, by stirring with heat followed by dilution to a coatable consistency. Ink can be coated, for example, onto a liner or the membrane itself by both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications. In some embodiments the cathode and/or anode catalyst can be secured to the membrane to form a catalyst coated membrane by pressure or a combination of pressure and temperature in a press or nip for roll attachment.

In some embodiments, the cathode and/or anode catalyst layer comprises nanostructured whiskers with the catalyst thereon. Nanostructured whiskers can be provided by techniques known in the art, including those described in U.S. Pat. No. 4,812,352 (Debe), U.S. Pat. No. 5,039,561 (Debe), U.S. Pat. No. 5,338,430 (Parsonage et al.), U.S. Pat. No. 6,136,412 (Spiewak et al.), and U.S. Pat. No. 7,419,741 (Vernstrom et al.), the disclosures of which are incorporated herein by reference. In general, nanostructured whiskers can be provided, for example, by vacuum depositing (e.g., by sublimation) a layer of organic or inorganic material onto a substrate (e.g., a microstructured catalyst transfer polymer sheet), and then, in the case of perylene red deposition, converting the perylene red pigment into nanostructured whiskers by thermal annealing. Typically the vacuum deposition steps are carried out at total pressures at or below about 10⁻³ Torr or 0.1 Pascal. Exemplary microstructures are made by thermal sublimation and vacuum annealing of the organic pigment C.I. Pigment Red 149 (i.e., N,N′-di(3,5-xylyl)perylene-3,4:9,10-bis(dicarboximide)). Methods for making organic nanostructured layers are disclosed, for example, in Materials Science and Engineering, A158 (1992), pp. 1-6; J. Vac. Sci. Technol. A, 5 (4), July/August 1987, pp. 1914-16; J. Vac. Sci. Technol. A, 6, (3), May/August 1988, pp. 1907-11; Thin Solid Films, 186, 1990, pp. 327-47; J. Mat. Sci., 25, 1990, pp. 5257-68; Rapidly Quenched Metals, Proc. of the Fifth Int. Conf. on Rapidly Quenched Metals, Wurzburg, Germany (Sep. 3-7, 1984), S. Steeb et al., eds., Elsevier Science Publishers B. V., New York, (1985), pp. 1117-24; Photo. Sci. and Eng., 24, (4), July/August 1980, pp. 211-16; and U.S. Pat. No. 4,340,276 (Maffitt et al.) and U.S. Pat. No. 4,568,598 (Bilkadi et al.), the disclosures of which are incorporated herein by reference. Properties of catalyst layers using carbon nanotube arrays are disclosed in the article “High Dispersion and Electrocatalytic Properties of Platinum on Well-Aligned Carbon Nanotube Arrays”, Carbon, 42 (2004), 191-197. Properties of catalyst layers using grassy or bristled silicon are disclosed, for example, in U.S. Pat. App. Pub. No. 2004/0048466 A1 (Gore et al.).

Vacuum deposition may be carried out in any suitable apparatus (see, e.g., U.S. Pat. No. 5,338,430 (Parsonage et al.), U.S. Pat. No. 5,879,827 (Debe et al.), U.S. Pat. No. 5,879,828 (Debe et al.), U.S. Pat. No. 6,040,077 (Debe et al.), and U.S. Pat. No. 6,319,293 (Debe et al.), and U.S. Pat. App. Pub. No. 2002/0004453 A1 (Haugen et al.), the disclosures of which are incorporated herein by reference.) One exemplary apparatus is depicted schematically in FIG. 4A of U.S. Pat. No. 5,338,430 (Parsonage et al.), and discussed in the accompanying text, wherein the substrate is mounted on a drum which is then rotated over a sublimation or evaporation source for depositing the organic precursor (e.g., perylene red pigment) prior to annealing the organic precursor in order to form the nanostructured whiskers.

Typically, the nominal thickness of deposited perylene red pigment is in a range from about 50 nm to 500 nm. Typically, the whiskers have an average cross-sectional dimension in a range from 20 nm to 60 nm and an average length in a range from 0.3 micrometer to 3 micrometers.

In some embodiments, the whiskers are attached to a backing. Exemplary backings comprise polyimide, nylon, metal foils, or other material that can withstand the thermal annealing temperature up to 300° C. In some embodiments, the backing has an average thickness in a range from 25 micrometers to 125 micrometers.

In some embodiments, the backing has a microstructure on at least one of its surfaces. In some embodiments, the microstructure is comprised of substantially uniformly shaped and sized features at least three (in some embodiments, at least four, five, ten, or more) times the average size of the nanostructured whiskers. The shapes of the microstructures can, for example, be V-shaped grooves and peaks (see, e.g., U.S. Pat. No. 6,136,412 (Spiewak et al.), the disclosure of which is incorporated herein by reference) or pyramids (see, e.g., U.S. Pat. No. 7,901,829 (Debe et al.), the disclosure of which is incorporated herein by reference). In some embodiments some fraction of the microstructure features extend above the average or majority of the microstructured peaks in a periodic fashion, such as every 31^{st} V-groove peak being 25% or 50% or even 100% taller than those on either side of it. In some embodiments, this fraction of features that extend above the majority of the microstructured peaks can be up to 10% (in some embodiments up to 3%, 2%, or even up to 1%). Use of the occasional taller microstructure features may facilitate protecting the uniformly smaller microstructure peaks when the coated substrate moves over the surfaces of rollers in a roll-to-roll coating operation. The occasional taller feature touches the surface of the roller rather than the peaks of the smaller microstructures, so much less of the nanostructured material or whisker material is likely to be scraped or otherwise disturbed as the substrate moves through the coating process. In some embodiments, the microstructure features are substantially smaller than half the thickness of the membrane that the catalyst will be transferred to in making a membrane electrode assembly. This is so that during the catalyst transfer process, the taller microstructure features do not penetrate through the membrane where they may overlap the electrode on the opposite side of the membrane. In some embodiments, the tallest microstructure features are less than ⅓^{rd} or ¼^{th} of the membrane thickness. For the thinnest ion exchange membranes (e.g., about 10 micrometers to 15 micrometers in thickness), it may be desirable to have a substrate with microstructured features no larger than about 3 micrometers to 4.5 micrometers tall. The steepness of the sides of the V-shaped or other microstructured features or the included angles between adjacent features may in some embodiments be desirable to be on the order of 90° for ease in catalyst transfer during a lamination-transfer process and to have a gain in surface area of the electrode that comes from the square root of two (1.414) surface area of the microstructured layer relative to the planar geometric surface of the substrate backing.

Exemplary catalysts contained in the anode catalyst layer include at least one of:

(a) at least one of elemental Au, Co, Fe, Ir, Mn, Ni, Os, Pd, Pt, Rh, or Ru;

(b) at least one alloy comprising at least one of Au, Co, Fe, Ir, Mn, Ni, Os, Pd, Pt, Rh, or Ru;

(c) at least one composite comprising at least one of Au, Co, Fe, Ir, Mn, Ni, Os, Pd, Pt, Rh, or

Ru;

(d) at least one oxide, hydrated oxide or hydroxide of at least one of Au, Co, Fe, Ir, Mn, Ni, Os, Pd, Pt, Rh, or Ru;

(e) at least one organometallic complex of at least one of Au, Co, Fe, Ir, Mn, Ni, Os, Pd, Pt, Rh, or Ru;

(f) at least one carbide of at least one of Au, Co, Fe, Ir, Mn, Ni, Os, Pd, Pt, Rh, or Ru;

(g) at least one fluoride of at least one of Au, Co, Fe, Ir, Mn, Ni, Os, Pd, Pt, Rh, or Ru;

(h) at least one nitride of at least one of Au, Co, Fe, Ir, Mn, Ni, Os, Pd, Pt, Rh, or Ru;

(i) at least one boride of at least one of Au, Co, Fe, Ir, Mn, Ni, Os, Pd, Pt, Rh, or Ru;

(j) at least one oxycarbide of at least one of Au, Co, Fe, Ir, Mn, Ni, Os, Pd, Pt, Rh, or Ru;

(k) at least one oxyfluoride of at least one of Au, Co, Fe, Ir, Mn, Ni, Os, Pd, Pt, Rh, or Ru;

(l) at least one oxynitride of at least one of Au, Co, Fe, Ir, Mn, Ni, Os, Pd, Pt, Rh, or Ru; or

(m) at least one oxyboride of at least one of Au, Co, Fe, Ir, Mn, Ni, Os, Pd, Pt, Rh, or Ru,

(where it is understood that the oxides, organometallic complexes, borides, carbides, fluorides, nitrides, oxyborides, oxycarbides, oxyfluorides, and oxynitrides are those that exist with Au, Co, Fe, Ir, Mn, Ni, Os, Pd, Pt, Rh, or Ru).

Exemplary oxides include CoO, CO₂O₃, Co₃O₄, CoFe₂O₄, FeO, Fe₂O₃, Fe₃O₄, Fe₄O₅, NiO, Ni₂O₃, NiₓFe_{y}O_{z}, NiₓCo_{y}O_{z}, MnO, Mn₂O₃, Mn₃O₄, IrₓO_{y} where Ir valence could be, for example, 2-8. Specific exemplary Ir oxides include Ir₂O₃, IrO₂, IrO₃, and IrO₄, as well as mixed IrₓRu_{y}O_{z}, IrₓPt_{y}O_{z}, IrₓRh_{y}O_{z}, IrₓRu_{y}Pt_{z}O_{zz}, IrₓRh_{y}Pt_{z}O_{z}, IrₓPd_{y}Pt_{z}O_{zz}, IrₓPd_{y}O_{z}, IrₓRu_{y}Pd_{z}O_{zz}IrₓRh_{y}Pd_{z}O_{zz}, or iridate Ir—Ru pyrochlore oxide (e.g., NaₓCe_{y}Ir_{z}Ru_{zz}O₇); Ru oxides include Ruₓ₁O_{y1}, where valence could be, for example, 2-8. Specific exemplary Ru oxides include Ru₂O₃, RuO₂, and RuO₃, or ruthenate Ru—Ir pyrochlore oxide (e.g., NaₓCe_{y}Ru_{z}Ir_{zz}O₇). Exemplary Pd oxides include PdₓO_{y} forms where Pd valence could be, for example, 1, 2, and 4. Specific exemplary Pd oxides include PdO, PdO₂. Other oxides include Os, Rh, or Au oxides OsO₂, OsO₄, RhO, RhO₂, Rh₂O₃, O_{y} and Au₂O₃, Au₂O, and AuₓO_{y}. Exemplary organometallic complexes include at least one of Au, Co, Fe, Ni, Ir, Pd, Rh, Os, or Ru, where Au, Co, Fe, Ir, Ni, Pd, Pt, Rh, or Ru form coordination bonds with organic ligands through hetero-atom(s) or non-carbon atom(s) (e.g., oxygen, nitrogen, chalcogens (e.g., sulfur and selenium), phosphorus, or halide). Exemplary Au, Co, Fe, Ir, Ni, Pd, Pt, Rh, Os, or Ru complexes with organic ligands can also be formed via π bonds. Organic ligands with oxygen hetero-atoms include functional groups such as hydroxyl, ether, carbonyl, ester, carboxyl, aldehydes, anhydrides, cyclic anhydrides, and epoxy. Organic ligands with nitrogen hetero atoms include functional groups such as amine, amide, imide, imine, azide, azine, pyrrole, pyridine, porphyrine, isocyanate, carbamate, carbamide sulfamate, sulfamide, amino acids, and N-heterocyclic carbine. Organic ligands with sulfur hetero atoms, so-called thio-ligands, include functional groups such as thiol, thioketone (thione or thiocarbonyl), thial, thiophene, disulfides, polysulfides, sulfimide, sulfoximide, and sulfonediimine. Organic ligands with phosphorus hetero-atoms include functional groups such as phosphine, phosphane, phosphanido, and phosphinidene. Exemplary organometallic complexes also include homo and hetero bimetallic complexes where Au, Co, Fe, Ir, Ni, Pd, Pt, Rh, Os, or Ru are involved in coordination bonds with either homo or hetero functional organic ligands. Au, Co, Fe, Ir, Ni, Pd, Pt, Rh, Os, or Ru organometallic complexes formed via π coordination bonds include carbon rich π-conjugated organic ligands (e.g., arenes, allyls, dienes, carbenes, and alkynyls). Examples of Au, Co, Fe, Ir, Ni, Pd, Pt, Rh, Os or Ru organometallic complexes are also known as chelates, tweezer molecules, cages, molecular boxes, fluxional molecules, macrocycles, prism, half-sandwich, and metal-organic framework (MOF). Exemplary organometallic compounds comprising at least one of Au, Co, Fe, Ir, Ni, Pd, Pt, Rh, Os, or Ru include compounds where Au, Co, Fe, Ir, Ni, Pd, Pt, Rh, Os, or Ru bond to organics via covalent, ionic or mixed covalent-ionic metal-carbon bonds. Exemplary organometallic compounds can also include a combination of at least two of Au, Co, Fe, Ir, Ni, Pd, Pt, Rh, Os, or Ru covalent bonds to carbon atoms and coordination bonds to organic ligands via hetero-atoms (e.g., oxygen, nitrogen, chalcogens (e.g., sulfur and selenium), phosphorus, or halide). Formulae of stable metallo-organic complexes can typically be predicted from the 18-electron rule. The rule is based on the fact that the valence shells of transition metals consist of nine valence orbitals, which collectively can accommodate 18 electrons as either bonding or nonbonding electron pairs. The combination of these nine atomic orbitals with ligand orbitals creates nine molecular orbitals that are either metal-ligand bonding or non-bonding. The rule is not generally applicable for complexes of non-transition metals. The rule usefully predicts the formulae for low-spin complexes of the Cr, Mn, Fe, and Co triads. Well-known examples include ferrocene, iron pentacarbonyl, chromium carbonyl, and nickel carbonyl. Ligands in a complex determine the applicability of the 18-electron rule. In general, complexes that obey the rule are composed at least partly of “7r-acceptor ligands” (also known as n-acids). This kind of ligand exerts a very strong ligand field, which lowers the energies of the resultant molecular orbitals and thus are favorably occupied. Typical ligands include olefins, phosphines, and CO. Complexes of r-acids typically feature metal in a low-oxidation state. The relationship between oxidation state and the nature of the ligands is rationalized within the framework of π backbonding. Exemplary carbides include Au₂C₂, Ni₂C, Ni₃C, NiC, Fe₂C, Fe₃C, FexCy, CoC, Co₂C, Co₃C, IrC, IrC₂, IrC₄, Ir₄C₅, IrxCy, RuC, Ru₂C, RhC, PtC, OsC, OsC₃, OsC₂, (MnFe)₃C, and Mn₃C. Exemplary fluorides include AuF, AuF₃, AuF₅, FeF₂, FeF₃, CoFe₂, CoF₃, NiF₂, IrF₃, IrF₄, IrxFy, PdF₃, PdF₄, RhF₃, RhF₄, RhF₆, RuF₃, and OsF₆. Exemplary nitrides include Au₃N, AuN₂, AuₓN_{y}, Ni₃N, NiN, Co₂N, CoN, Co₂N₃, Co₄N, Fe₂N, Fe₃Nₓ with x=0.75-1.4, Fe₄N, Fe₈N, Fe₁₆N₂, IrN, IrN₂, IrN₃, RhN, RhN₂, RhN₃, Ru₂N, RuN, RuN₂, PdN, PdN₂, OsN, OsN₂, OsN₄, Mn₂N, Mn₄N, and Mn₃N. Exemplary borides include AuₓB_{y}, Mn₂AuB, NiB, Ni₃B, Ni₄B₃, CoB, Co₂B, Co₃B, FeB, Fe₂B, Ru₂B₃, RuB₂, IrB, IrₓB_{y}, OsB, Os₂B₃, OsB₂, RhB, ZrRh₃B, NbRh₃B and YRh₃B. Exemplary oxycarbides AuₓO_{y}C_{z}, NiₓO_{y}C_{z}, FeₓO_{y}C_{z}, CoₓO_{y}C_{z}, IrₓO_{y}C_{z}, RuₓO_{y}C_{z}, RhₓO_{y}C_{z}, PtₓO_{y}C_{z}, PdₓO_{y}C_{z}, and OsₓO_{y}C_{z}. Exemplary oxyfluorides include AuₓO_{y}F_{z}, NiₓO_{y}F_{z}, FeₓO_{y}F_{z}, CoₓO_{y}F_{z}, IrₓO_{y}F_{z}, RuₓO_{y}F_{z}, RhₓO_{y}F_{z}, PtₓO_{y}F_{z}, PdₓO_{y}F_{z}, and OsₓO_{y}F_{z}. Exemplary oxynitrides include AuₓO_{y}N_{z}, NiₓO_{y}N_{z}, FeₓO_{y}N_{z}, CoₓO_{y}N_{z}, IrₓO_{y}N_{z}, RuₓO_{y}N_{z}, RhₓO_{y}N_{z}, PtₓO_{y}N_{z}, PdₓO_{y}N_{z}, and OsₓO_{y}N_{z}. Exemplary oxyborides include AuₓO_{y}B_{z}, NiₓO_{y}B_{z}, FeₓO_{y}B_{z}, CoₓO_{y}B_{z}, IrₓO_{y}B_{z}, RuₓO_{y}B_{z}, RhₓO_{y}B_{z}, PtₓO_{y}B_{z}, PdₓO_{y}B_{z}, and OsₓO_{y}B_{z}. It is within the scope of the present disclosure to include composites comprising these oxides, organometallic complexes, carbides, fluorides, nitrides, oxycarbides, oxyfluorides, oxynitrides oxyborides, boronitrides, and/or borocarbides.

Exemplary catalysts contained in a cathode catalyst layer include at least one of:

(a″) at least one of elemental Au, Co, Fe, Ir, Mn, Ni, Os, Pd, Pt, Rh, or Ru;

(b″) at least one alloy comprising at least one of Au, Co, Fe, Ir, Mn, Ni, Os, Pd, Pt, Rh, or Ru;

(c″) at least one composite comprising at least one of Au, Co, Fe, Ir, Mn, Ni, Os, Pd, Pt, Rh, or Ru;

(d″) at least one oxide of at least one of Au, Co, Fe, Ir, Mn, Ni, Os, Pd, Pt, Rh, or Ru;

(e″) at least one organometallic complex of at least one of Au, Co, Fe, Ir, Mn, Ni, Os, Pd, Pt, Rh, or Ru;

(f″) at least one carbide of at least one of Au, Co, Fe, Ir, Mn, Ni, Os, Pd, Pt, Rh, or Ru;

(g″) at least one fluoride of at least one of Au, Co, Fe, Ir, Mn, Ni, Os, Pd, Pt, Rh, or Ru;

(h″) at least one nitride of at least one of Au, Co, Fe, Ir, Mn, Ni, Os, Pd, Pt, Rh, or Ru;

(i″) at least one boride of at least one of Au, Co, Fe, Ir, Mn, Ni, Os, Pd, Pt, Rh, or Ru;

(j″) at least one oxycarbide of at least one of Au, Co, Fe, Ir, Mn, Ni, Os, Pd, Pt, Rh, or Ru;

(k″) at least one oxyfluoride of at least one of Au, Co, Fe, Ir, Mn, Ni, Os, Pd, Pt, Rh, or Ru; or

(l″) at least one oxynitride of at least one of Au, Co, Fe, Ir, Mn, Ni, Os, Pd, Pt, Rh, or Ru; or

(m″) at least one oxyboride of at least one of Au, Co, Fe, Ir, Mn, Ni, Os, Pd, Pt, Rh, or Ru

(where it is understood that the oxides, organometallic complexes, borides, carbides, fluorides, nitrides, oxyborides, oxycarbides, oxyfluorides, and oxynitrides are those that exist with Au, Co, Fe, Ir, Mn, Ni, Os, Pd, Pt, Rh, or Ru).

Exemplary oxides include CoO, Co₂O₃, C₃O₄, CoFe₂O₄, FeO, Fe₂O₃, Fe₃O₄, Fe₄O₅, NiO, Ni₂O₃, NiₓFe_{y}O_{z}, NiₓCo_{y}O_{z}; MnO, Mn₂O₃, Mn₃O₄, and IrₓO_{y}, where Ir valence could be, for example, 2-8. Specific exemplary Ir oxides include Ir₂O₃, IrO₂, IrO₃, and IrO₄, as well as mixed IrₓRu_{y}O_{z}, IrₓPt_{y}O_{z}, IrₓRh_{y}O_{z}, IrₓRu_{y}Pt_{z}O_{zz}, IrₓRh_{y}Pt_{z}O_{zz}, IrₓPd_{y}Pt_{z}O_{zz}, IrₓPd_{y}O_{z}, IrₓRu_{y}Pd_{z}O_{zz}, IrₓRh_{y}Pd_{z}O_{zz}, or iridate Ir—Ru pyrochlore oxide (e.g., NaₓCe_{y}Ir_{z}Ru_{zz}O₇); Ru oxides include Ruₓ₁O_{y1}, where valence could be, for example, 2-8. Specific exemplary Ru oxides include Ru₂O₃, RuO₂, and RuO₃, or ruthenate Ru—Ir pyrochlore oxide (e.g., NaₓCe_{y}Ru_{z}Ir_{zz}O₇). Exemplary Pd oxides include PdₓO_{y} forms where Pd valence could be, for example, 1, 2, and 4. Specific exemplary Pd oxides include PdO, PdO₂, Os oxides OsO₂ and OsO₄, RhO, RhO₂, Rh₂O₃, Au₂O₃, Au₂O, and AuₓO_{y}. Exemplary organometallic complexes include at least one of Au, Co, Fe, Ni, Ir, Mn, Pd, Pt, Rh, Os, or Ru, where Au, Co, Fe, Ir, Ni, Pd, Pt, Rh, Os, or Ru coordination bonds with organic ligands through hetero-atom(s) or non-carbon atom(s) (e.g., oxygen, nitrogen, chalcogens (e.g., sulfur and selenium), phosphorus, or halide). Exemplary Au, Co, Fe, Ir, Ni, Pd, Pt, Rh, Os, or Ru complexes with organic ligands can also be formed via π bonds. Organic ligands with oxygen hetero-atoms include functional groups such as hydroxyl, ether, carbonyl, ester, carboxyl, aldehydes, anhydrides, cyclic anhydrides, and epoxy. Organic ligands with nitrogen hetero atoms include functional groups such as amine, amide, imide, imine, azide, azine, pyrrole, pyridine, porphyrine, isocyanate, carbamate, carbamide, sulfamate, sulfamide, amino acids, and N-heterocyclic carbine. Organic ligands with sulfur hetero atoms, so-called thio-ligands include functional groups (e.g., thiol, thioketone (thione or thiocarbonyl), thial, thiophene, disulfides, polysulfides, sulfimide, sulfoximide, and sulfonediimine). Organic ligands with phosphorus hetero-atoms include functional groups (e.g., phosphine, phosphane, phosphanido, and phosphinidene). Exemplary organometallic complexes also include homo and hetero bimetallic complexes where Au, Co, Fe, Ir, Ni, Pd, Pt, Rh, Os, or Ru are involved in coordination bonds with either homo or hetero functional organic ligands. Au, Co, Fe, Ir, Ni, Pd, Pt, Rh, Os, or Ru organometallic complexes formed via π coordination bonds include carbon rich π-conjugated organic ligands (e.g., arenes, allyls, dienes, carbenes, and alkynyls). Examples of Au, Co, Fe, Ir, Ni, Pd, Pt, Rh, Os, or Ru organometallic complexes are also known as chelates, tweezer molecules, cages, molecular boxes, fluxional molecules, macrocycles, prism, half-sandwich, and metal-organic framework (MOF). Exemplary organometallic compounds comprising at least one of Au, Co, Fe, Ir, Ni, Pd, Pt, Rh, Os, or Ru include compounds where Au, Co, Fe, Ir, Ni, Pd, Pt, Rh, Os, or Ru bond to organics via covalent, ionic, or mixed covalent-ionic metal-carbon bonds. Exemplary organometallic compounds can also include combinations of at least two of Au, Co, Fe, Ir, Ni, Pd, Pt, Rh, Os, or Ru covalent bonds to carbon atoms and coordination bonds to organic ligands via hetero-atoms (e.g., oxygen, nitrogen, chalcogens (e.g., sulfur and selenium), phosphorus, or halide). Formulae of stable metallo-organic complexes can typically be predicted from the 18-electron rule. The rule is based on the fact that the valence shells of transition metals consist of nine valence orbitals, which collectively can accommodate 18 electrons as either bonding or nonbonding electron pairs. The combination of these nine atomic orbitals with ligand orbitals creates nine molecular orbitals that are either metal-ligand bonding or non-bonding. The rule is not generally applicable for complexes of non-transition metals. The rule usefully predicts the formulae for low-spin complexes of the Cr, Mn, Fe, and Co triads. Well-known examples include ferrocene, iron pentacarbonyl, chromium carbonyl, and nickel carbonyl. Ligands in a complex determine the applicability of the 18-electron rule. In general, complexes that obey the rule are composed at least partly of t-acceptor ligands (also known as π-acids). This kind of ligand exerts a very strong ligand field, which lowers the energies of the resultant molecular orbitals and thus are favorably occupied. Typical ligands include olefins, phosphines, and CO. Complexes of t-acids typically feature metal in a low-oxidation state. The relationship between oxidation state and the nature of the ligands is rationalized within the framework of π backbonding. Exemplary carbides include Au₂C₂, or other elements carbides (e.g., Ni₂C, Ni₃C, NiC, Fe₂C, Fe₃C, FeₓC_{y}, CoC, Co₂C, Co₃C, IrC, IrC₂, IrC₄, Ir₄C₅, IrₓC_{y}, Ru₂C, RuC, RhC, PtC, OsC, OsC₃, and OsC₂). Exemplary fluorides include AuF, AuF₃, AuF₅, FeF₂, FeF₃, CoFe₂, CoF₃, NiF₂, IrF₃, IrF₄, IrₓF_{y}, PdF₃, PdF₄, RhF₃, RhF₄, RhF₆, RuF₃, and OsF₆. Exemplary nitrides include Au₃N, AuN₂, AuₓN_{y}, Ni₃N, NiN, Co₂N, CoN, Co₂N₃, Co₄N, Fe₂N, Fe₃Nₓ with x=0.75-1.4, Fe₄N, FesN, Fe₁₆N₂, IrN, IrN₂, IrN₃, RhN, RhN₂, RhN₃, Ru₂N, RuN, RuN₂, PdN, PdN₂, OsN, OsN₂, and OsN₄. Exemplary borides include AuₓB_{y}, Mn₂AuB, NiₓB_{y}, CoB, Co₂B, Co₃B, FeB, Fe₂B, Ru₂B₃, RuB₂, IrB, IrₓB_{y}, OsB, Os₂B₃, OsB₂, RhB, and their oxyborides, boronitrides and borocarbides. Exemplary oxycarbides include AuₓO_{y}C_{z}, NiₓO_{y}C_{z}, FeₓO_{y}C_{z}, CoₓO_{y}C_{z}, IrₓO_{y}C_{z}, RuₓO_{y}C_{z}, RhₓO_{y}C_{z}, PtₓO_{y}C_{z}, PdₓO_{y}C_{z}, and OsₓO_{y}C_{z}. Exemplary oxyfluorides include AuₓO_{y}F_{z}, NiₓO_{y}F_{z}, FeₓO_{y}F_{z}, CoₓO_{y}F_{z}, IrₓO_{y}F_{z}, RuₓO_{y}F_{z}, RhₓO_{y}F_{z}, PtₓO_{y}F_{z}, PdₓO_{y}F_{z}, and OsₓO_{y}F_{z}. Exemplary oxynitrides include AuₓO_{y}N_{z}, NiₓO_{y}N_{z}, FeₓO_{y}N_{z}, CoₓO_{y}N_{z}, IrₓO_{y}N_{z}, RuₓO_{y}N_{z}, RhₓO_{y}N_{z}, PtₓO_{y}N_{z}, PdₓO_{y}N_{z}, and OsₓO_{y}N_{z}. It is within the scope of the present disclosure to include composites comprising these oxides, organometallic complexes, carbides, fluorides, nitrides, borides, oxycarbides, oxyfluorides, oxynitrides, and/or oxyborides.

In some embodiments, the anode catalyst layer comprises support materials comprising at least one of:

(a′) at least one of elemental Al, carbon, Hf, Nb, Re, Si, Sn, Ta, Ti, W, or Zr;

(b′) at least one alloy comprising at least one of Al, carbon, Hf, Nb, Re, Si, Sn, Ta, Ti, W, or Zr;

(c′) at least one composite comprising at least one of Al, carbon, Hf, Nb, Re, Si, Sn, Ta, Ti, W, or Zr;

(d′) at least one oxide of at least one of Al, Hf, Nb, Re, Si, Sn, Ta, Ti, W, or Zr;

(e′) at least one organometallic complex of at least one of Al, Hf, Nb, Re, Si, Sn, Ta, Ti, W, or Zr;

(f′) at least one carbide of at least one of Al, Hf, Nb, Re, Si, Sn, Ta, Ti, W, or Zr;

(g′) at least one fluoride of at least one of Al, carbon, Hf, Nb, Re, Si, Sn, Ta, Ti, W, or Zr;

(h′) at least one nitride of at least one of Al, carbon, Hf, Nb, Re, Si, Sn, Ta, Ti, W, or Zr;

(i′) at least one oxycarbide of at least one of Al, Hf, Nb, Re, Si, Sn, Ta, Ti, W, or Zr;

(j′) at least one oxyfluoride of at least one of Al, Hf, Nb, Re, Si, Sn, Ta, Ti, W, or Zr;

(k′) at least one oxynitride of at least one of Al, carbon, Hf, Nb, Re, Si, Sn, Ta, Ti, W, or Zr;

(l′) at least one boride of at least one of Al, carbon, Hf, Nb, Re, Si, Sn, Ta, Ti, W, or Zr; or

(m′) at least one oxyboride of at least one of Al, Hf, Nb, Re, Si, Sn, Ta, Ti, W, or Zr

(where it is understood that the oxides, organometallic complexes, borides, carbides, fluorides, nitrides, oxyborides, oxycarbides, oxyfluorides, oxynitrides, borides, and oxyborides are those that exist with Al, carbon, Hf, Nb, Re, Si, Sn, Ta, Ti, W, or Zr).

Exemplary oxides include HfO, Hf₂O₃, HfO₂, TaO, Ta₂O₅, SnO, SnO₂, TiO, Ti₂O₃, TiO₂, TiₓO_{y}, ZrO, Zr₂O₃, ZrO₂, yttria-stabilized zirconia (YSZ), W₂O₃, WO₃, ReO₂, ReO₃, Re₂O₃, Re₂O₇, NbO, NbO₂, Nb₂O₅, Al₂O₃, AlO, Al₂O, SiO, and SiO₂. Exemplary organometallic complexes include at least one of Al, Hf, Nb, Re, Si, Sn, Ta, Ti, W, or Zr, where Al, Hf, Nb, Re, Si, Sn, Ta, Ti, W, or Zr form coordination bonds with organic ligands through hetero-atom(s) or non-carbon atom(s) (e.g., oxygen, nitrogen, chalcogens (e.g., sulfur and selenium), phosphorus, or halide). Exemplary Al, Hf, Nb, Re, Si, Sn, Ta, Ti, W, or Zr complexes with organic ligands can also be formed via π bonds. Organic ligands with oxygen hetero-atoms include functional groups such as hydroxyl, ether, carbonyl, ester, carboxyl, aldehydes, anhydrides, cyclic anhydrides, and epoxy. Organic ligands with nitrogen hetero atoms include functional groups such as amine, amide, imide, imine, azide, azine, pyrrole, pyridine, porphyrine, isocyanate, carbamate, carbamide, sulfamate, sulfamide, amino acids, and N-heterocyclic carbine. Organic ligands with sulfur hetero atoms, so-called thio-ligands include functional groups (e.g., thiol, thioketone (thione or thiocarbonyl), thial, thiophene, disulfides, polysulfides, sulfimide, sulfoximide, and sulfonediimine). Organic ligands with phosphorus hetero-atoms include functional groups (e.g., phosphine, phosphane, phosphanido, and phosphinidene). Exemplary organometallic complexes also include homo and hetero bimetallic complexes where Al, Hf, Nb, Re, Si, Sn, Ta, Ti, W, or Zr are involved in coordination bonds with either homo or hetero functional organic ligands. Al, Hf, Nb, Re, Si, Sn, Ta, Ti, W, or Zr organometallic complexes formed via π coordination bonds include carbon rich n-conjugated organic ligands (e.g., arenes, allyls, dienes, carbenes, and alkynyls). Examples of Al, Hf, Nb, Re, Si, Sn, Ta, Ti, W, or Zr organometallic complexes are also known as chelates, tweezer molecules, cages, molecular boxes, fluxional molecules, macrocycles, prism, half-sandwich, and metal-organic framework (MOF). Exemplary organometallic compounds comprising at least one of Al, Hf, Nb, Re, Si, Sn, Ta, Ti, W, or Zr include compounds where Al, Hf, Nb, Re, Si, Sn, Ta, Ti, W, or Zr bond to organics via covalent, ionic, or mixed covalent-ionic metal-carbon bonds. Exemplary organometallic compounds can also include combinations of at least two of Al, Hf, Nb, Re, Si, Sn, Ta, Ti, W, or Zr covalent bonds to carbon atoms and coordination bonds to organic ligands via hetero-atoms (e.g., oxygen, nitrogen, chalcogens (e.g., sulfur and selenium), phosphorus, or halide). Formulae of stable metallo-organic complexes can typically be predicted from the 18-electron rule. The rule is based on the fact that the valence shells of transition metals consist of nine valence orbitals, which collectively can accommodate 18 electrons as either bonding or nonbonding electron pairs. The combination of these nine atomic orbitals with ligand orbitals creates nine molecular orbitals that are either metal-ligand bonding or non-bonding. The rule is not generally applicable for complexes of non-transition metals. Ligands in a complex determine the applicability of the 18-electron rule. In general, complexes that obey the rule are composed at least partly of π-acceptor ligands (also known as π-acids). This kind of ligand exerts a very strong ligand field, which lowers the energies of the resultant molecular orbitals and thus are favorably occupied. Typical ligands include olefins, phosphines, and CO. Complexes of π-acids typically feature metal in a low-oxidation state. The relationship between oxidation state and the nature of the ligands is rationalized within the framework of π backbonding. For additional details see, for example, Organometallic Chemistry of Titanium, Zirconium, and Hafnium, A volume in Organometallic Chemistry: A Series of Monographs, Author(s): P. C. Wailes, ISBN: 978-0-12-730350-5. Exemplary carbides include HfC and HfC₂, Nb₂C, Nb₄C₃ and NbC, Re₂C, TaC, Ta₄C₃, Ta₂C, WC, W₂C, WC₂, Zr₂C, Zr₃C₂, Zr₆C, TiC, Ti₈C₁₂⁺ clusters, and ternary Ti—Al—C, and Ti—Sn—C carbide phases (e.g., Ti₃AlC, Ti₃AlC₂, Ti₂AlC, Ti₂SnC, Al₄C₃, SnC, Sn₂C, and Al₄C₃). Exemplary fluorides include ZrF₄, TiF₄, TiF₃, TaF₅, NbF₄, NbF₅, WF₆, AlF₃, HfF₄, CF, CFₓ, (CF)ₓ, SnF₂, and SnF₄. Exemplary nitrides include Hf₃N₄, HfN, Re₂N, Re₃N, ReN, Nb₂N, NbN, Nb carbonitride, TaN, Ta₂N, TasN₆, Ta₃N₅, W₂N, WN, WN₂, Zr₃N₄, ZrN, β-C₃N₄, graphitic g-C₃N₄, and Si₃N₄. Exemplary oxycarbides include AlₓO_{y}C_{z}, HfₓO_{y}C_{z}, ZrₓO_{y}C_{z}, TiₓO_{y}C_{z}, TaₓO_{y}C_{z}, ReₓO_{y}C_{z}, NbₓO_{y}C_{z}, WₓO_{y}C_{z}, and SnₓO_{y}C_{z}. Exemplary oxyfluorides include AlₓO_{y}F_{z}, HfₓO_{y}F_{z}, ZrₓO_{y}F_{z}, TiₓO_{y}F_{z}, TaₓO_{y}F_{z}, ReₓO_{y}F_{z}, NbₓO_{y}F_{z}, WₓO_{y}F_{z}, and SnₓO_{y}F_{z}. Exemplary oxynitrides include AlₓO_{y}N_{z}, HfₓO_{y}N_{z}, ZrₓO_{y}N_{z}, TiₓO_{y}N_{z}, TaₓO_{y}N_{z}, ReₓO_{y}N_{z}, NbₓO_{y}N_{z}, WₓO_{y}N_{z}, CₓO_{y}Nₓ, and SnₓO_{y}N_{z}. Exemplary borides include ZrB₂, TiB₂, TaB, Ta₅B₆, Ta₃B₄, TaB₂, NbB₂, NbB, WB, WB₂, AlB₂, HfB₂, ReB₂, B₄C, SiB₃, SiB₄, SiB₆, and their oxyborides, boronitrides, and borocarbides. It is within the scope of the present disclosure to include composites comprising these oxides, organometallic complexes, carbides, fluorides, nitrides, oxycarbides, oxyfluorides, and/or oxynitrides. The composition and amount of various components of multicomponent catalysts can affect the performance catalyst and the overall performance of the device the catalyst is used in (e.g., too much Ti in a Pt anode catalyst was observed to lower the overall cell performance).

In some embodiments, the cathode or anode catalyst layer comprises support materials comprising at least one of:

(a′″) at least one of elemental Al, carbon, Hf, Nb, Re, Si, Sn, Ta, Ti, W, or Zr;

(b′″) at least one alloy comprising at least one of Al, carbon, Hf, Nb, Re, Si, Sn, Ta, Ti, W, or Zr;

(c′″) at least one composite comprising at least one of Al, carbon, Hf, Nb, Re, Si, Sn, Ta, Ti, W, or Zr;

(d′″) at least one oxide of at least one of Al, Hf, Nb, Re, Si, Sn, Ta, Ti, W, or Zr;

(e′″) at least one organometallic complex of at least one of Al, Hf, Nb, Re, Si, Sn, Ta, Ti, W, or Zr;

(f′″) at least one carbide of at least one of Al, Hf, Nb, Re, Si, Sn, Ta, Ti, W, or Zr;

(g′″) at least one fluoride of at least one of Al, carbon, Hf, Nb, Re, Si, Sn, Ta, Ti, W, or Zr;

(h′″) at least one nitride of at least one of Al, carbon, Hf, Nb, Re, Si, Sn, Ta, Ti, W, or Zr;

(i′″) at least one oxycarbide of at least one of Al, Hf, Nb, Re, Si, Sn, Ta, Ti, W, or Zr;

(j′″) at least one oxyfluoride of at least one of Al, Hf, Nb, Re, Si, Sn, Ta, Ti, W, or Zr;

(k′″) at least one oxynitride of at least one of Al, carbon, Hf, Nb, Re, Si, Sn, Ta, Ti, W, or Zr;

(l′″) at least one boride of at least one of Al, carbon, Hf, Nb, Re, Si, Sn, Ta, Ti, W, or Zr; or

(m′″) at least one oxyboride of at least one of Al, Hf, Nb, Re, Si, Sn, Ta, Ti, W, or Zr

(where it is understood that the oxides, organometallic complexes, borides carbides, fluorides, nitrides, oxycarbides, oxyfluorides, oxyborides, and oxynitrides are those that exist with a′″).

Exemplary oxides include HfO, Hf₂O₃, HfO₂, TaO, Ta₂Os, SnO, SnO₂, TiO, Ti₂O₃, TiO₂, TiₓO_{y}, ZrO, Zr₂O₃, ZrO₂, yttria-stabilized zirconia (YSZ), W₂O₃, WO₃, ReO₂, ReO₃, Re₂O₃, Re₂O₇, NbO, NbO₂, Nb₂O₅, Al₂O₃, AlO, Al₂O, SiO, and SiO₂. Exemplary organometallic complexes include at least one of Al, Hf, Nb, Re, Si, Sn, Ta, Ti, W, or Zr, where Al, Hf, Nb, Re, Si, Sn, Ta, Ti, W, or Zr form coordination bonds with organic ligands through hetero-atom(s) or non-carbon atom(s) (e.g., oxygen, nitrogen, chalcogens (e.g., sulfur and selenium), phosphorus, or halide). Exemplary Al, Hf, Nb, Re, Si, Sn, Ta, Ti, W, or Zr complexes with organic ligands can also be formed via π bonds. Organic ligands with oxygen hetero-atoms include functional groups such as hydroxyl, ether, carbonyl, ester, carboxyl, aldehydes, anhydrides, cyclic anhydrides, and epoxy. Organic ligands with nitrogen hetero atoms include functional groups such as amine, amide, imide, imine, azide, azine, pyrrole, pyridine, porphyrine, isocyanate, carbamate, carbamide, sulfamate, sulfamide, amino acids, and N-heterocyclic carbine. Organic ligands with sulfur hetero atoms, so-called thio-ligands include functional groups (e.g., thiol, thioketone (thione or thiocarbonyl), thial, thiophene, disulfides, polysulfides, sulfimide, sulfoximide, and sulfonediimine). Organic ligands with phosphorus hetero-atoms include functional groups (e.g., phosphine, phosphane, phosphanido, and phosphinidene). Exemplary organometallic complexes also include homo and hetero bimetallic complexes where Al, Hf, Nb, Re, Si, Sn, Ta, Ti, W, or Zr are involved in coordination bonds with either homo or hetero functional organic ligands. Al, Hf, Nb, Re, Si, Sn, Ta, Ti, W, or Zr organometallic complexes formed via π coordination bonds include carbon rich π-conjugated organic ligands (e.g., arenes, allyls, dienes, carbenes, and alkynyls). Examples of Al, Hf, Nb, Re, Si, Sn, Ta, Ti, W, or Zr organometallic complexes are also known as chelates, tweezer molecules, cages, molecular boxes, fluxional molecules, macrocycles, prism, half-sandwich, and metal-organic framework (MOF). Exemplary organometallic compounds comprising at least one of Al, Hf, Nb, Re, Si, Sn, Ta, Ti, W, or Zr include compounds where Al, Hf, Nb, Re, Si, Sn, Ta, Ti, W, or Zr bond to organics via covalent, ionic, or mixed covalent-ionic metal-carbon bonds. Exemplary organometallic compounds can also include combinations of at least two of Al, Hf, Nb, Re, Si, Sn, Ta, Ti, W, or Zr covalent bonds to carbon atoms and coordination bonds to organic ligands via hetero-atoms (e.g., oxygen, nitrogen, chalcogens (e.g., sulfur and selenium), phosphorus, or halide). Formulae of stable metallo-organic complexes can typically be predicted from the 18-electron rule. The rule is based on the fact that the valence shells of transition metals consist of nine valence orbitals, which collectively can accommodate 18 electrons as either bonding or nonbonding electron pairs. The combination of these nine atomic orbitals with ligand orbitals creates nine molecular orbitals that are either metal-ligand bonding or non-bonding. The rule is not generally applicable for complexes of non-transition metals. Ligands in a complex determine the applicability of the 18-electron rule. In general, complexes that obey the rule are composed at least partly of t-acceptor ligands (also known as π-acids). This kind of ligand exerts a very strong ligand field, which lowers the energies of the resultant molecular orbitals and thus are favorably occupied. Typical ligands include olefins, phosphines, and CO. Complexes of π-acids typically feature metal in a low-oxidation state. The relationship between oxidation state and the nature of the ligands is rationalized within the framework of π backbonding. For additional details see, for example, Organometallic Chemistry of Titanium, Zirconium, and Hafnium, A volume in Organometallic Chemistry: A Series of Monographs, Author(s): P. C. Wailes, ISBN: 978-0-12-730350-5. Exemplary carbides include HfC, HfC₂, Nb₂C, Nb₄C₃, NbC, Re₂C, TaC, Ta₄C₃, Ta₂C, WC, W₂C, WC₂, Zr₂C, Zr₃C₂, Zr₆C, TiC, Ti₈C₁₂⁺ clusters, and ternary carbide phases (e.g., Ti₃AlC, Ti₃AlC₂, Ti₂AlC, Ti₂SnC, Al₄C₃, SnC, Sn₂C, and Al₄C₃). Exemplary fluorides include ZrF₄, TiF₄, TiF₃, TaF₅, NbF₄, NbF₅, WF₆, AlF₃, HfF₄, CF, CFₓ, (CF)ₓ, SnF₂, and SnF₄. Exemplary nitrides include Hf₃N₄, HfN, Re₂N, Re₃N, ReN, Nb₂N, NbN, Nb carbonitride, TaN, Ta₂N, TasN₆, Ta₃N₅, W₂N, WN, WN₂, β-C₃N₄, graphitic g-C₃N₄, Zr₃N₄, and ZrN. Exemplary oxycarbides include AlₓO_{y}C_{z}, HfₓO_{y}C_{z}, ZrₓO_{y}C_{z}, TiₓO_{y}C_{z}, TaₓO_{y}C_{z}, ReₓO_{y}C_{z}, NbₓO_{y}C_{z}, WₓO_{y}C_{z}, and SnₓO_{y}C_{z}. Exemplary oxyfluorides include AlₓO_{y}F_{z}, HfₓO_{y}F_{z}, ZrₓO_{y}F_{z}, TiₓO_{y}F_{z}, TaₓO_{y}F_{z}, ReₓO_{y}F_{z}, NbₓO_{y}F_{z}, WₓO_{y}F_{z}, and SnₓO_{y}F_{z}. Exemplary oxynitrides include AlₓO_{y}N_{z}, HfₓO_{y}N_{z}, ZrₓO_{y}N_{z}, TiₓO_{y}N_{z}, TaₓO_{y}N_{z}, ReₓO_{y}N_{z}, NbₓO_{y}N_{z}, WₓO_{y}N_{z}, and SnₓO_{y}N_{z}. Exemplary borides include ZrB₂, TiB₂, TaB, Ta₅B₆, Ta₃B₄, TaB₂, NbB₂, NbB, WB, WB₂, AlB₂, HfB₂, ReB₂, C₄B, SiB₃, SiB₄, SiB₆, and their boronitrides and borocarbides. It is within the scope of the present disclosure to include composites comprising these oxides, organometallic complexes, carbides, fluorides, nitrides, oxycarbides, oxyfluorides, and/or oxynitrides.

The catalyst and catalyst support materials can be deposited, as applicable, by techniques known in the art. Exemplary deposition techniques include those independently selected from the group consisting of sputtering (including reactive sputtering), atomic layer deposition, molecular organic chemical vapor deposition, metal-organic chemical vapor deposition, molecular beam epitaxy, thermal physical vapor deposition, vacuum deposition by electrospray ionization, and pulse laser deposition. Thermal physical vapor deposition method uses suitable desired temperature (e.g., via resistive heating, electron beam gun, or laser) to melt or sublimate the target (source material) into vapor state which is in turn passed through a vacuum space, then condensing of the vaporized form to substrate surfaces. Thermal physical vapor deposition equipment is known in the art, including that available, for example, as a metal evaporator from CreaPhys GmbH under the trade designation “METAL EVAPORATOR” (ME-Series) or as an organic materials evaporator available from Mantis Deposition LTD, Oxfordshire, UK, under the trade designation “ORGANIC MATERIALS EVAPORATIOR” (ORMA-Series)”. Catalysts comprising multiple alternating layers can be sputtered, for example, from multiple targets (e.g., Nb is sputtered from a first target, Zr is sputtered from a second target, Hf from a third (if present), etc.), or from a target(s) comprising more than one element. If the catalyst coating is done with a single target, it may be desirable that the coating layer be applied in a single step onto the gas distribution layer, catalyst transfer layer, or membrane so that the heat of condensation of the catalyst coating heats the underlying catalyst or support Al, carbon, Hf, Ta, Si, Sn, Ti, Zr, or W, etc. atoms as applicable and substrate surface sufficient to provide enough surface mobility that the atoms are well mixed and form thermodynamically stable alloy domains. Alternatively, for example, the substrate can also be provided hot or heated to facilitate this atomic mobility. In some embodiments, sputtering is conducted at least in part in an atmosphere comprising at least a mixture of argon and oxygen, and wherein the ratio of argon to oxygen flow rates in to the sputtering chamber are at least 113 sccm/7 sccm. Organometallic forms of catalysts and catalyst support materials can be deposited, as applicable, for example, by soft or reactive landing of mass selected ions. Soft landing of mass-selected ions is used to transfer catalytically-active metal complexes complete with organic ligands from the gas phase onto an inert surface. This method can be used to prepare materials with defined active sites and thus achieve molecular design of surfaces in a highly controlled way under either ambient or traditional vacuum conditions. For additional details see, for example, Johnson et al., Anal. Chem., 2010, 82, pp. 5718-5727, and Johnson et al., Chemistry: A European Journal, 2010, 16, pp. 14433-14438, the disclosures of which are incorporated herein by reference.

In some embodiments, it may be desirable to include an oxygen evolution reaction catalyst into a membrane electrode assembly. Incorporation of oxygen evolution reaction (OER) catalysts (e.g., Ru, Ir, RuIr, or their oxides) tend to favor water electrolysis over carbon corrosion or catalyst degradation/dissolution, aiding in fuel cell durability during transient conditions by reducing cell voltage. Ru has been observed to exhibit excellent OER activity but it is preferably stabilized. Ir is well known for being able to stabilize Ru, while Ir itself has been observed to exhibit good OER activity.

In some embodiments, in a membrane electrode assembly or unitized electrode assembly described herein there is at least one of:
a layer comprising oxygen evolution reaction catalyst disposed on the first major surface of the first gas distribution layer;
the first gas distribution layer comprising oxygen evolution reaction catalyst;
a layer comprising oxygen evolution reaction catalyst disposed on the second major surface of the first gas distribution layer;
a layer comprising oxygen evolution reaction catalyst disposed between the first gas distribution layer and the first gas dispersion layer;
a layer comprising oxygen evolution reaction catalyst disposed on the first major surface of the first gas dispersion layer;
the first gas dispersion layer comprising oxygen evolution reaction catalyst;
a layer comprising oxygen evolution reaction catalyst disposed on the second major surface of the first gas dispersion layer;
a layer comprising oxygen evolution reaction catalyst disposed on the first major surface of the second gas dispersion layer;
the second gas dispersion layer comprising oxygen evolution reaction catalyst;
a layer comprising oxygen evolution reaction catalyst disposed on the second major surface of the second gas dispersion layer;
a layer comprising oxygen evolution reaction catalyst disposed between the second gas distribution layer and the second gas dispersion layer;
a layer comprising oxygen evolution reaction catalyst disposed on the first major surface of the second gas distribution layer;
the second gas distribution layer comprising oxygen evolution reaction catalyst; and
a layer comprising oxygen evolution reaction catalyst disposed on the second major surface of the second gas distribution layer.

Physically separating the oxygen evolution reaction (OER) catalyst from the Pt-based hydrogen oxidation reaction (HOR) catalyst on the anode side or the Pt-based oxygen reduction reaction (ORR) catalyst on the cathode side of a hydrogen polymer electrolyte membrane (PEM) fuel cell has been found to result in a substantial improvement in catalyst durability for gas switching events such as startup/shutdown or cell reversal (due to local fuel starvation). A further advantage is that OER catalyst can be varied independently of the choice of anode and cathode catalyst layers applied to the polymer electrolyte membrane. Thus, the OER catalyst can be used with catalyst coated membranes having a variety of HOR and ORR catalyst layers, such as Pt supported on carbon or Pt on nanostructured thin film supports. The OER catalyst loading, processing, and performance-enhancing additives can be adjusted to meet the specific customer's needs for their particular anode, cathode, hold requirements, etc. This approach also permits a variety of catalyst coated membrane (CCM) and membrane electrode assembly (MEA) constructions in which OER catalyst on or in a gas distribution layer or gas dispersion layer is one component, in addition to which another layer of catalyst is added.

An oxygen evolution reaction catalyst is preferably adapted to be in electrical contact with an external circuit when the membrane electrode assembly is used in an electrochemical device such as a fuel cell. This is possible because, in many polymer electrolyte membrane fuel cell constructions, the first gas distribution layer and second gas distribution layer are electrically conductive. Although not wanting to be bound by theory, it is believed that for a successful incorporation of OER catalysts, it is desired to prevent them from blocking or affecting the Pt hydrogen oxidation reaction (HOR), or vice versa.

An oxygen evolution reaction electrocatalyst participates in electrochemical oxygen evolution reactions. Catalyst materials modify and increase the rate of chemical reactions without being consumed in the process. Electrocatalysts are a specific form of catalysts that function at electrode surfaces or may be the electrode surface itself. An electrocatalyst can be heterogeneous, such as an iridium surface, coating or nanoparticles, or homogeneous, like a dissolved coordination complex. The electrocatalyst assists in transferring electrons between the electrode and reactants, and/or facilitates an intermediate chemical transformation described by an overall half-reaction.

The oxygen evolution reaction catalyst can be deposited by techniques known in the art. Exemplary deposition techniques include those independently selected from the group consisting of sputtering (including reactive sputtering), atomic layer deposition, molecular organic chemical vapor deposition, molecular beam epitaxy, thermal physical vapor deposition, vacuum deposition by electrospray ionization, and pulse laser deposition. Additional general details can be found, for example, in U.S. Pat. No. 5,879,827 (Debe et al.), U.S. Pat. No. 6,040,077 (Debe et al.), and U.S. Pat. No. 7,419,741 (Vernstrom et al.), the disclosures of which are incorporated herein by reference. The thermal physical vapor deposition method uses suitable elevated temperature (e.g., via resistive heating, electron beam gun, or laser) to melt or sublimate the target (source material) into vapor state which is in turn passed through a vacuum space, then condensing of the vaporized form onto substrate surfaces. Thermal physical vapor deposition equipment is known in the art, including that available, for example, as a metal evaporator or as an organic molecular evaporator from CreaPhys GmbH, Dresden, Germany, under the trade designations “METAL EVAPORATOR (ME-Series)” or “ORGANIC MOLECULAR EVAPORATOR (DE-Series)” respectively; another example of an organic materials evaporator is available from Mantis Deposition LTD, Oxfordshire, UK, under the trade designation “ORGANIC MATERIALS EVAPORATIOR (ORMA-Series)”. Catalysts comprising multiple alternating layers can be sputtered, for example, from multiple targets (e.g., Ir is sputtered from a first target, Pd is sputtered from a second target, Ru from a third (if present), etc.), or from a target(s) comprising more than one element. If the catalyst coating is done with a single target, it may be desirable that the coating layer be applied in a single step onto the gas distribution layer, gas dispersion layer, catalyst transfer layer, or membrane, so that the heat of condensation of the catalyst coating heats the underlying catalyst or support Au, Co, Fe, Ir, Mn, Ni, Os, Pd, Pt, Rh, or Ru, etc. atoms as applicable and substrate surface sufficient to provide enough surface mobility that the atoms are well mixed and form thermodynamically stable alloy domains. Alternatively, for example, the substrate can also be provided hot or heated to facilitate this atomic mobility. In some embodiments, sputtering is conducted at least in part in an atmosphere comprising at least a mixture of argon and oxygen, and wherein the ratio of argon to oxygen flow rates into the sputtering chamber are at least 113 sccm/7 sccm (standard cubic centimeters per minute).

Organometallic forms of catalysts can be deposited, for example, by soft or reactive landing of mass selected ions. Soft landing of mass-selected ions is used to transfer catalytically-active metal complexes complete with organic ligands from the gas phase onto an inert surface. This method can be used to prepare materials with defined active sites and thus achieve molecular design of surfaces in a highly controlled way under either ambient or traditional vacuum conditions. For additional details see, for example, Johnson et al., Anal. Chem., 2010, 82, pp. 5718-5727, and Johnson et al., Chemistry: A European Journal, 2010, 16, pp. 14433-14438, the disclosures of which are incorporated herein by reference.

In some embodiments, at least one of the following conditions holds:

(a) at least one of the layers comprising the oxygen evolution reaction catalyst has an elemental metal Pt to elemental metal oxygen evolution reaction catalyst ratio (i.e., the ratio of the number of Pt atoms to Ru atoms, if RuO₂ is the oxygen evolution reaction catalyst) of not greater than 1:1 (in some embodiments, not greater than 0.9:1, 0.8:1, 0.75:1, 0.7:1, 0.6:1, 0.5:1, 0.4:1, 0.3:1, 0.25:1, 0.2:1, or even not greater than 0.1:1, or even 0:1); or

(b) at least one of the layers disposed on at least one of the first gas distribution layer, the second gas distribution layer, the optional first gas dispersion layer, or the optional second gas dispersion layer comprising the oxygen evolution reaction catalyst has an elemental metal Pt to elemental metal oxygen evolution reaction catalyst ratio of not greater than 1:1 (in some embodiments, not greater than 0.9:1, 0.8:1, 0.75:1, 0.7:1, 0.6:1, 0.5:1, 0.4:1, 0.3:1, 0.25:1, 0.2:1, or even not greater than 0.1:1, or even 0:1).

In some embodiments, a membrane electrode assembly or a unitized electrode assembly of the present disclosure has at least one of (i.e., any one, as well as any combination of the following, wherein it is understood that reference to the first and second gas dispersion layers is intended if either optional layer is present):

a layer comprising oxygen evolution reaction catalyst (e.g., at least a portion present) disposed on (e.g., attached to) the first major surface of the first gas distribution layer;

the first gas distribution layer comprising oxygen evolution reaction catalyst (e.g., at least a portion present, which includes distributed throughout the layer);

a layer comprising oxygen evolution reaction catalyst (e.g., at least a portion present, which includes distributed throughout the layer) disposed on (e.g., attached to) the second major surface of the first gas distribution layer;

a layer comprising oxygen evolution reaction catalyst (e.g., at least a portion present, which includes distributed throughout the layer) disposed between the first gas distribution layer and the first gas dispersion layer;

a layer comprising oxygen evolution reaction catalyst disposed (e.g., at least a portion present, which includes distributed throughout the layer) on (e.g., attached to) the first major surface of the first gas dispersion layer;

the first gas dispersion layer comprising oxygen evolution reaction catalyst (e.g., at least a portion present, which includes distributed throughout the layer);

a layer comprising oxygen evolution reaction catalyst disposed (e.g., at least a portion present, which includes distributed throughout the layer) on (e.g., attached to) the second major surface of the first gas dispersion layer;

a layer comprising oxygen evolution reaction catalyst disposed (e.g., at least a portion present, which includes distributed throughout the layer) on (e.g., attached to) the first major surface of the second gas dispersion layer;

the second gas dispersion layer comprising oxygen evolution reaction catalyst (e.g., at least a portion present, which includes distributed throughout the layer);

a layer comprising oxygen evolution reaction catalyst disposed (e.g., at least a portion present, which includes distributed throughout the layer) on (e.g., attached to) the second major surface of the second gas dispersion layer;

a layer comprising oxygen evolution reaction catalyst (e.g., at least a portion present, which includes distributed throughout the layer) disposed between the second gas distribution layer and the second gas dispersion layer;

a layer comprising oxygen evolution reaction catalyst disposed (e.g., at least a portion present, which includes distributed throughout the layer) on (e.g., attached to) the first major surface of the second gas distribution layer;

the second gas distribution layer comprising oxygen evolution reaction catalyst (e.g., at least a portion present, which includes distributed throughout the layer); and a layer comprising oxygen evolution reaction catalyst disposed (e.g., at least a portion present which includes distributed throughout the layer) on (e.g., attached to) the second major surface of the second gas distribution layer,

wherein the portion present is an amount of at least 0.5 microgram/cm², in some embodiments, 1 microgram/cm², 1.5 microgram/cm², 2 micrograms/cm², 2.5 micrograms/cm², 3 micrograms/cm², or even at least 5 micrograms/cm²; in some embodiments, in a range from 0.5 microgram/cm² to 100 micrograms/cm², 0.5 microgram/cm² to 75 micrograms/cm², 0.5 microgram/cm² to 50 micrograms/cm², 0.5 microgram/cm² to 25 micrograms/cm², 1 microgram/cm² to 100 micrograms/cm², 1 microgram/cm² to 75 micrograms/cm², 1 microgram/cm² to 50 micrograms/cm², 1 microgram/cm² to 25 micrograms/cm², 2 micrograms/cm² to 100 micrograms/cm², 2 micrograms/cm² to 75 micrograms/cm², 2 micrograms/cm² to 50 micrograms/cm², 2 micrograms/cm² to 30 micrograms/cm², 2 micrograms/cm² to 25 micrograms/cm², or even 2 micrograms/cm² to 20 micrograms/cm², based on the elemental metal content of the oxygen evolution reaction catalyst.

In some embodiments, at least the first and/or second gas distribution layer, if present, is essentially free of Pt (i.e., less than 0.1 microgram/cm² Pt).

Membrane electrode assemblies and unitized electrode assemblies described herein, as well as devices incorporating membrane electrode assemblies and unitized electrode assemblies described herein, are generally made using techniques known in the art, but modified with the constructions requirements or options described herein.

A gas dispersion layer further distributes the gas from the gas distribution layer generally more evenly to the electrode, generally protects the catalyst layer and membrane from mechanical defects owing to the possible roughness of the gas distribution layer, and in some embodiments conducts electricity and reduces the electrical contact resistance with the adjacent catalyst layer. It also may provide effective wicking of liquid water from the catalyst layer into the diffusion layer. An exemplary gas dispersion layer is a microporous layer. Microporous layers can be formed, for example, by impregnating or/and coating a gas distribution layer such as carbon papers or cloths with additives such as water repelling hydrophobic binding agents (e.g., fluoropolymers or fluorinated ethylene propylene resin (FEP)) and carbon black. Carbon papers or cloths are typically first immersed in a dispersed solution/emulsion of a water repellent hydrophobic agent, in a solvent (e.g., water or alcohol), followed by drying and thermal treatment; then a carbon slurry is coated on the substrate followed by drying and thermal treatment. Exemplary fluoropolymers such as polytetrafluoroethylene (PTFE) (available, for example, from Ensinger GmbH, Nufringen, Germany, under the trade designation “TECAFLON PTFE NATURAL;” 3M Dyneon, St. Paul, Minn., under the trade designation “3M DYNEON PTFE TF;” Baillie Advanced Materials LLC, Edinburgh, United Kingdom, under the trade designation “BAM PTFE;” and E.I. du Pont de Nemours, Wilmington, Del., under the trade designations “DUPONT PTFE;” ETFE (poly(ethene-co-tetrafluoroethene) (fluorothermoplastic) available, for example, from Baillie Advanced Materials LLC under the trade designation “BAM ETFE;” Ensinger GmbH under the trade designation “TECAFLON ETFE NATURAL;” and E.I. du Pont de Nemours under the trade designation “DUPONT ETFE;” and PVDF (poly-vinylidenefluoride), available, for example, from Ensinger GmbH under the trade designation “TECAFLON PVDF;” 3M Dyneon under the trade designation “3M DYNEON FLUOROPLASTIC PVDF;” and Baillie Advanced Materials LLC under the trade designation “BAM PVDF.” Exemplary sources of fluorinated ethylene propylene resin (FEP) are available from E.I. du Pont de Nemours under the trade designation “DUPONT TEFLON FEP” and Daikin North America LLC under the trade designation “NEOFLON DISPERSION” (FEP-based/PFA-based). Exemplary sources of a carbon black powder include Acetylene Black, available from manufacturers including Alfa Aesar, Ward Hill, Mass., or oil furnace carbon black, which is available from Cabot Corporation, Boston, Mass., under the trade designation “VULCAN XC-72.”

Exemplary membranes include polymer electrolyte membranes. Exemplary polymer electrolytes membranes include those comprising anionic functional groups bound to a common backbone, which are typically sulfonic acid groups, but may also include carboxylic acid groups, imide groups, amide groups, or other acidic functional groups. The polymer electrolytes used in making membrane electrode assemblies described herein are typically highly fluorinated, and more typically perfluorinated. The polymer electrolytes used in making membrane electrode assemblies described herein are typically copolymers of tetrafluoroethylene and at least fluorinated, acid-functional comonomers. Exemplary polymer electrolytes include those from E.I. du Pont de Nemours, Wilmington, Del., under the trade designation “NAFION” and from Asahi Glass Co. Ltd., Japan, under the trade designation “FLEMION”. The polymer electrolyte may be obtained from a copolymer of tetrafluoroethylene (TFE) and FSO₂CF₂CF₂CF₂CF₂—O—CF═CF₂ by hydrolysis as described, for example, in U.S. Pat. No. 6,624,328 (Guerra) and U.S. Pat. No. 7,348,088 (Freemeyer et al.), the disclosures of which are incorporated herein by reference. The polymer typically has an equivalent weight (EW) of 1200 or less, 1100 or less, 1000 or less, 900 or less, or even 800 or less.

The process of providing or incorporating the catalyst layer into the gas distribution layer and the catalyst support layer can also be based on a liquid phase. Suitable coating methods include suspension, electrophoretic, or electrochemical deposition and impregnation. For example, when the gas dispersion layer can be applied from a slurry onto the gas distribution layer, the slurry can contain the catalyst particles in addition to the carbon particles and fluoropolymer binder. For additional details see, for example, the review by Valerie Meille, Applied Catalysis A General, 315, 2006, pp. 1-17, the disclosure of which is incorporated herein by reference.

It will be understood by one skilled in the art that the crystalline and morphological structure of a catalyst described herein, including the presence, absence, or size of alloys, amorphous zones, crystalline zones of one or a variety of structural types, and the like, may be highly dependent upon process and manufacturing conditions, particularly when three or more elements are combined.

In some embodiments, the first layer of catalyst is deposited directly on nanostructured whiskers. In some embodiments, the first layer is at least one of covalently or ionically bonded to the nanostructured whiskers. In some embodiments, the first layer is adsorbed onto the nanostructured whiskers. The first layer can be formed, for example, as a uniform conformal coating or as dispersed discrete nanoparticles. Dispersed discrete tailored nanoparticles can be formed, for example, by a cluster beam deposition method by regulating the pressure of helium carrier gas or by self-organization. For additional details see, for example, Wan et al., Solid State Communications, 121, 2002, pp. 251-256 or Bruno Chaudret, Top. Organomet. Chem., 2005, 16, pp. 233-259, the disclosures of which are incorporated herein by reference.

Articles described herein are useful, for example, in membrane electrode assemblies and electrochemical devices (e.g., fuel cells, redox flow batteries, and electrolyzers).

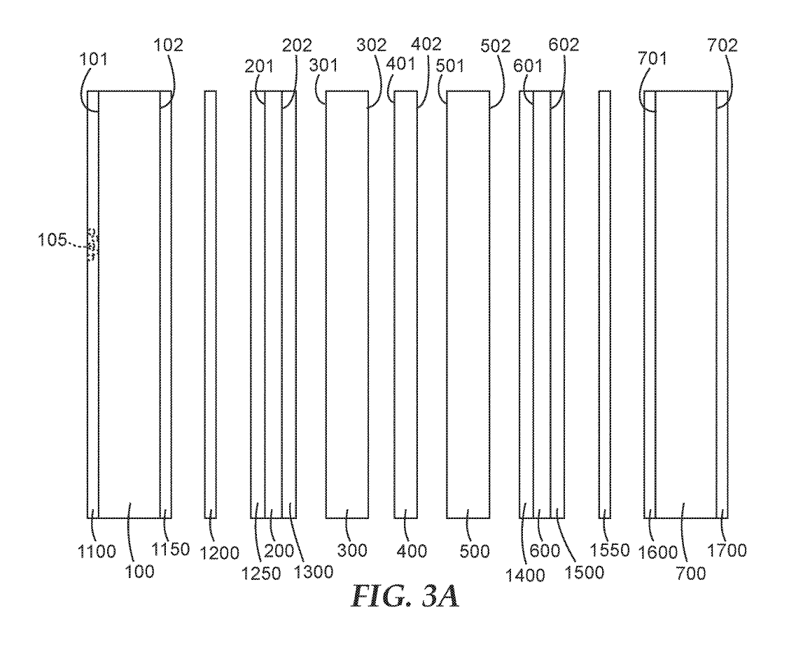

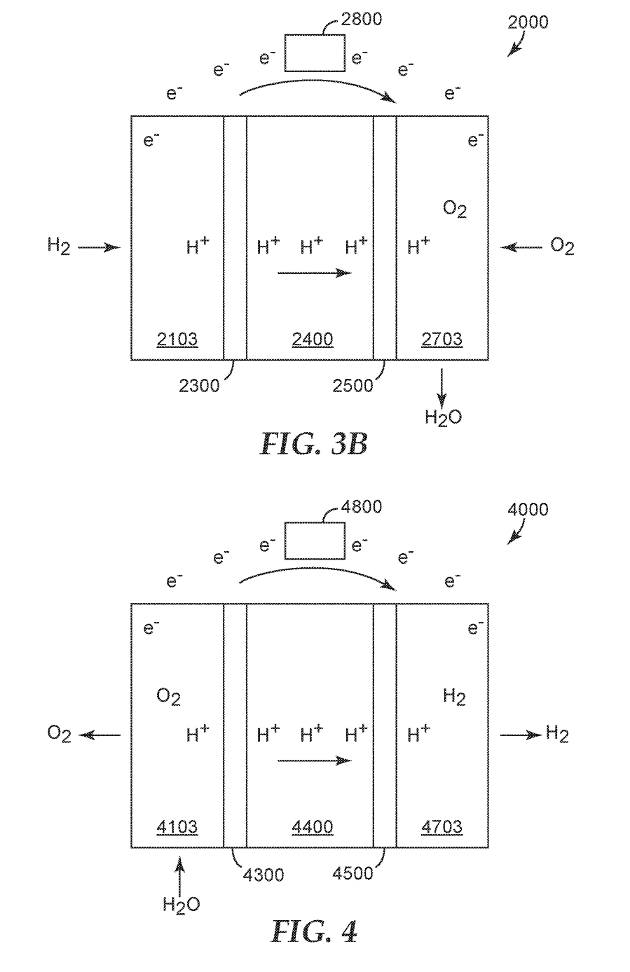

Referring to FIG. 3A, in some embodiments, an exemplary membrane electrode assembly or a unitized electrode assembly also has at least one of:

layer 1100 comprising oxygen evolution reaction (OER) catalyst 105 disposed on first major surface 101 of first gas distribution layer 100;

layer 1150 comprising a porous adhesive layer disposed on second major surface 102 of first gas distribution layer 100;

layer 1200 comprising a porous adhesive layer disposed between first gas distribution layer 100 and first gas dispersion layer 200;

layer 1250 comprising a porous adhesive layer disposed on first major surface 201 of first gas dispersion layer 200;

layer 1300 comprising a porous adhesive layer disposed on second major surface 202 of first gas dispersion layer 200;

layer 1400 comprising a porous adhesive layer disposed on first major surface 601 of second gas dispersion layer 600;

layer 1500 comprising a porous adhesive layer disposed on second major surface 602 of second gas dispersion layer 600;

layer 1550 comprising a porous adhesive layer disposed between second gas distribution layer 600 and second gas dispersion layer 700; and layer 1600 comprising a porous adhesive layer disposed on first major surface 701 of second gas distribution layer 700. As shown, oxygen evolution reaction catalyst 105 is present in layer 1100, although an oxygen evolution reaction catalyst could be advantageously added to any of layers 1100, 100, 1150, 1200, 1250, 200, 1300, 1400, 600, 1500, 1600, 700, or 1700 of a hydrogen fuel cell, as described in co-owned U.S. Pat. Application 62/091,851, MEMBRANE ELECTRODE ASSEMBLY, filed Dec. 15, 2014, which is hereby incorporated by reference in its entirety.

Optional oxygen evolution reaction catalyst 105, shown here in layer 1100 disposed on first gas distribution layer 100, is preferably adapted to be in electrical contact with an external circuit when the membrane electrode assembly (MEA) is used in an electrochemical device such as a fuel cell. This is possible because, in many polymer electrolyte membrane (PEM) fuel cell constructions, first gas distribution layer 100 and second gas distribution layer 700, as well as optional first and second gas dispersion layers 200 and 600, are electrically conductive.

Referring to FIG. 3B, exemplary fuel cell 2000 includes first gas diffusion layer (GDL) 2103 (which comprises a gas distribution layer and optionally a gas dispersion layer) adjacent anode catalyst layer 2300. First GDL 2103 comprises at least first gas distribution layer 100 of FIG. 3A, and optionally further comprises at least one of elements 1100, 1150, 1200, 1250, 200, or 1300 of FIG. 3A. Also adjacent anode catalyst layer 2300, on the opposite side from GDL 2103, is electrolyte membrane 2400. Cathode catalyst layer 2500 is adjacent electrolyte membrane 2400, and second gas diffusion layer 2703 is adjacent the cathode catalyst layer 2500. Second GDL 2703 comprises at least second gas distribution layer 700 of FIG. 3A, and optionally further comprises at least one of gas dispersion layer 600 and layers 1400, 1500, 1550, 1600, or 1700 of FIG. 3A. GDLs 2103 and 2703 can be referred to as diffuse current collectors (DCCs) or fluid transport layers (FTLs). In operation, hydrogen fuel is introduced into the anode portion of fuel cell 2000, passing through first gas diffusion layer 2103 and over anode catalyst layer 2300. At anode catalyst layer 2300, the hydrogen fuel is separated into hydrogen ions (H⁺) and electrons (e⁻).

Electrolyte membrane 2400 permits only the hydrogen ions or protons to pass through electrolyte membrane 2400 to the cathode portion of fuel cell 2000. The electrons cannot pass through electrolyte membrane 2400 and, instead, flow through an external electrical circuit in the form of electric current. This current can power, for example, electric load 2800, such as an electric motor, or be directed to an energy storage device, such as a rechargeable battery.

Oxygen flows into the cathode side of fuel cell 2000 via second gas diffusion layer 2703. As the oxygen passes over cathode catalyst layer 2500, oxygen, protons, and electrons combine to produce water and heat. In some embodiments, the fuel cell catalyst in the anode catalyst layer, the cathode catalyst layer, or both, comprises no electrically conductive carbon-based material (i.e., the catalyst layer may comprise, for example, perylene red, fluoropolymers, or polyolefins).

A similar electrochemical device, a polymer electrolyte membrane (PEM) water electrolyzer, is essentially a PEM hydrogen fuel cell running in reverse. FIGS. 1, 2A, 2B, and 3A would be generically the same for a PEM water electrolyzer as for a hydrogen fuel cell. However, the choice of materials and operating conditions would be different, as described below and shown in FIG. 4. With the fuel cell, hydrogen and oxygen are brought into the cell, and electricity and water come out. With a PEM water electrolyzer, water and electricity are put into the cell, and hydrogen and oxygen gases come out. Also, some materials are different, since different electrochemical half-cell reactions are involved at the electrodes, and the electrodes operate at different electrical potentials. For example, the catalyst for the “oxygen reaction electrode” in a water electrolyzer would be optimized for the oxygen evolution reaction (OER), which produces oxygen gas from water, rather than for the oxygen reduction reaction (ORR), which would be the desired oxygen reaction in a hydrogen fuel cell. To make things more complicated, the definitions of anode and cathode are based on the direction of flow of positive ions (i.e., cations toward the cathode) in the cell, and are thus different for spontaneous reactions (e.g., fuel cells,) versus driven reactions (electrolysis.) The “oxygen electrode” where oxygen is reduced (to water) in a fuel cell is called the fuel cell cathode, while the “oxygen electrode” where oxygen is produced or evolved (from water) in an electrolyzer is called the electrolyzer anode. Electrolysis is not a spontaneous process, so electrical energy must be provided to drive the reaction, and due to electrical resistance and other inefficiencies, electrolyzers must be operated at higher cell voltages than fuel cells. The higher voltages require more durable materials in order to avoid corrosion and side reactions.

Referring to FIG. 4, exemplary PEM water electrolyzer 4000 includes first gas diffusion layer (GDL) 4103 adjacent electrolyzer anode catalyst layer 4300. First GDL 4103 comprises at least first gas distribution layer 100 of FIG. 3A, and optionally further comprises at least one of elements 200, 1100, 1150, 1200, 1250, or 1300 of FIG. 3A. Also adjacent electrolyzer anode catalyst layer 4300, on the opposite side from GDL 4103, is electrolyte membrane 4400. Electrolyzer cathode catalyst layer 4500 is adjacent electrolyte membrane 4400, and second gas diffusion layer 4703 is adjacent the electrolyzer cathode catalyst layer 4500. Second GDL 4703 comprises at least second gas distribution layer 700 of FIG. 3A, and optionally further comprises at least one of elements 600, 1400, 1500, 1550, 1600, and 1700 of FIG. 3A. GDLs 4103 and 4703 can be referred to as diffuse current collectors (DCCs) or fluid transport layers (FTLs). In operation, purified water is introduced into the electrolyzer anode portion of electrolyzer 4000, passing through first gas diffusion layer 4103 and over electrolyzer anode catalyst layer 4300. At electrolyzer anode catalyst layer 4300, the energy source or power supply 4800 extracts electrons (e⁻) from the water and forces them to the other electrode. The water is separated into hydrogen ions (H⁺) and oxygen molecules, O₂, and the oxygen gas exits the cell. The hydrogen ions (H⁺) migrate through polymer electrolyte membrane 4400 under the influence of the applied cell voltage established by power supply 4800. At the catalyst layer 4500 of the other electrode, the hydrogen ions (H⁺) combine with the electrons (e⁻) to form hydrogen gas H₂, which exits the cell.

Electrolyte membrane 4400 permits only the hydrogen ions or protons to pass through electrolyte membrane 4400 to the electrolyzer cathode portion of water electrolyzer 4000. The electrons forced onto the electrolyzer cathode catalyst 4500 by the power supply 4800 cannot pass through electrolyte membrane 4400, so instead the hydrogen ions pass through the membrane under the influence of the electric field established across membrane 4400 by power supply 4800. Once the hydrogen ions reach the electrolyzer cathode catalyst 4500, they combine with the electrons to produce hydrogen gas, which exits the cell.

### EXEMPLARY EMBODIMENTS

### 1A

An article comprising a first gas distribution layer, a first gas dispersion layer, or a first electrode layer, having first and second opposed major surfaces and a first adhesive layer having first and second opposed major surfaces, wherein the second major surface of the first gas distribution layer, the second major surface of the first gas dispersion layer, or the first major surface of the first electrode layer, as applicable, has a central area, wherein the first major surface of the first adhesive layer contacts at least the central area of the second major surface of the first gas distribution layer, the first major surface of the first adhesive layer contacts at least the central area of the second major surface of the first gas dispersion layer, or the second major surface of the first adhesive layer contacts at least the central area of the first major surface of the first electrode layer, as applicable, and wherein the first adhesive layer comprises a porous network of first adhesive including a continuous pore network extending between the first and second major surfaces of the first adhesive layer.

### 2A

The article of Exemplary Embodiment 1A, wherein the porous network of first adhesive comprises a plurality of first elongated adhesive elements.

### 3A

The article of Exemplary Embodiment 2A, wherein the first elongated adhesive elements have an aspect ratio of at least of at least 10:1 (in some embodiments, an aspect ratio of at least 100:1 to 1000:1, or even at least 10000:1).

### 4A

The article of either Exemplary Embodiment 2A or 3A, wherein the first elongated adhesive elements have lengths of at least 10 micrometers (in some embodiments, at least 25 micrometers, 100 micrometers, or even at least 1 centimeter) and at least one of diameters or widths in a range from 50 nm to 10000 nm (in some embodiments, in the range from 100 nm to 2000 nm, 200 nm to 1000 nm, or even 300 nm to 500 nm).

### 5A

The article of any of Exemplary Embodiments 2A to 4A, wherein the first elongated adhesive elements include fibers.

### 6A

The article of any preceding A Exemplary Embodiment, wherein the first adhesive comprises at least one of fluorinated thermoplastic (e.g., poly(tetrafluroethylene-co-vinylidene fluoride-co-hexafluporopropylene) or polyvinylidene fluoride) or hydrocarbon thermoplastic (e.g., acrylate and rubber, styrene).

### 7A

The article of any preceding A Exemplary Embodiment, wherein the first adhesive layer has porosity of at least 50 percent (in some embodiments, at least 55, 60, 65, 70, 75, 80, 90 or even at least 95; in some embodiments, in the range from 50 to 90, 60 to 80, or even 60 to 75) percent, based on the total volume of the first adhesive layer.

### 8A

The article of any preceding A Exemplary Embodiment, wherein the first adhesive layer has a thickness up to 10 micrometers (in some embodiments, up to 9 micrometers, 8 micrometers, 7 micrometers, 6 micrometers, 5 micrometers, 4 micrometers, 3 micrometers, 2 micrometers, or even up to 1 micrometer; in some embodiments, in a range from 0.5 micrometer to 10 micrometers, 0.5 micrometer to 5 micrometers, or even 0.5 micrometer to 2 micrometers).

### 9A

The article of any preceding A Exemplary Embodiment further comprising a first catalyst layer having first and second opposed major surfaces, wherein the second major surface of the first adhesive layer contacts the first major surface of the first catalyst layer.

### 10A

The article of Exemplary Embodiment 9A, wherein the first catalyst layer is an anode catalyst layer.

### 11A

The article of Exemplary Embodiment 10A, wherein the anode catalyst layer comprises at least one of:

(a) at least one of elemental Au, Co, Fe, Ir, Mn, Ni, Os, Pd, Pt, Rh, or Ru;

(b) at least one alloy comprising at least one of Au, Co, Fe, Ir, Mn, Ni, Os, Pd, Pt, Rh, or Ru;

(c) at least one composite comprising at least one of Au, Co, Fe, Ir, Mn, Ni, Os, Pd, Pt, Rh, or Ru;

(d) at least one oxide, hydrated oxide, or hydroxide of at least one of Au, Co, Fe, Ir, Mn, Ni, Os, Pd, Pt, Rh, or Ru;

(e) at least one organometallic complex of at least one of Au, Co, Fe, Ir, Mn, Ni, Os, Pd, Pt, Rh, or Ru;

(f) at least one carbide of at least one of Au, Co, Fe, Ir, Mn, Ni, Os, Pd, Pt, Rh, or Ru;

(g) at least one fluoride of at least one of Au, Co, Fe, Ir, Mn, Ni, Os, Pd, Pt, Rh, or Ru;

(h) at least one nitride of at least one of Au, Co, Fe, Ir, Mn, Ni, Os, Pd, Pt, Rh, or Ru;

(i) at least one boride of at least one of Au, Co, Fe, Ir, Mn, Ni, Os, Pd, Pt, Rh, or Ru;

(j) at least one oxycarbide of at least one of Au, Co, Fe, Ir, Mn, Ni, Os, Pd, Pt, Rh, or Ru;

(k) at least one oxyfluoride of at least one of Au, Co, Fe, Ir, Mn, Ni, Os, Pd, Pt, Rh, or Ru;

(l) at least one oxynitride of at least one of Au, Co, Fe, Ir, Mn, Ni, Os, Pd, Pt, Rh, or Ru; or

(m) at least one oxyboride of at least one of Au, Co, Fe, Ir, Mn, Ni, Os, Pd, Pt, Rh, or Ru.

### 12A

The article of either Exemplary Embodiment 10A or 11A, wherein the anode catalyst layer further comprises at least one of:

(a′) at least one of elemental Al, carbon, Hf, Nb, Re, Si, Sn, Ta, Ti, W, or Zr;

(b′) at least one alloy comprising at least one of Al, carbon, Hf, Nb, Re, Si, Sn, Ta, Ti, W, or Zr;

(c′) at least one composite comprising at least one of Al, carbon, Hf, Nb, Re, Si, Sn, Ta, Ti, W, or Zr;

(d′) at least one oxide of at least one of Al, Hf, Nb, Re, Si, Sn, Ta, Ti, W, or Zr;

(e′) at least one organometallic complex of at least one of Al, Hf, Nb, Re, Si, Sn, Ta, Ti, W, or Zr;

(f′) at least one carbide of at least one of Al, Hf, Nb, Re, Si, Sn, Ta, Ti, W, or Zr;

(g′) at least one fluoride of at least one of Al, carbon, Hf, Nb, Re, Si, Sn, Ta, Ti, W, or Zr;

(h′) at least one nitride of at least one of Al, carbon, Hf, Nb, Re, Si, Sn, Ta, Ti, W, or Zr;

(i′) at least one oxycarbide of at least one of Al, Hf, Nb, Re, Si, Sn, Ta, Ti, W, or Zr;

(j′) at least one oxyfluoride of at least one of Al, Hf, Nb, Re, Si, Sn, Ta, Ti, W, or Zr;

(k′) at least one oxynitride of at least one of Al, carbon, Hf, Nb, Re, Si, Sn, Ta, Ti, W, or Zr;

(l′) at least one boride of at least one of Al, carbon, Hf, Nb, Re, Si, Sn, Ta, Ti, W, or Zr; or

(m′) at least one oxyboride of at least one of Al, Hf, Nb, Re, Si, Sn, Ta, Ti, W, or Zr.

### 13A

The article of any of Exemplary Embodiment 10A to 12A, wherein the anode catalyst layer comprises nanostructured whiskers with the catalyst thereon.

### 14A

The article of Exemplary Embodiment 9A, wherein the first catalyst layer is a cathode catalyst layer.

### 15A

The article of Exemplary Embodiment 14A, wherein the cathode catalyst layer comprises at least one of:

(a″) at least one of elemental Au, Co, Fe, Ir, Mn, Ni, Os, Pd, Pt, Rh, or Ru;

(b″) at least one alloy comprising at least one of Au, Co, Fe, Ir, Mn, Ni, Os, Pd, Pt, Rh, or Ru;

(c″) at least one composite comprising at least one of Au, Co, Fe, Ir, Mn, Ni, Os, Pd, Pt, Rh, or Ru;

(d″) at least one oxide of at least one of Au, Co, Fe, Ir, Mn, Ni, Os, Pd, Pt, Rh, or Ru;

(e″) at least one organometallic complex of at least one of Au, Co, Fe, Ir, Mn, Ni, Os, Pd, Pt, Rh, or Ru;

(f″) at least one carbide of at least one of Au, Co, Fe, Ir, Mn, Ni, Os, Pd, Pt, Rh, or Ru;

(g″) at least one fluoride of at least one of Au, Co, Fe, Ir, Mn, Ni, Os, Pd, Pt, Rh, or Ru;

(h″) at least one nitride of at least one of Au, Co, Fe, Ir, Mn, Ni, Os, Pd, Pt, Rh, or Ru;

(i″) at least one boride of at least one of Au, Co, Fe, Ir, Mn, Ni, Os, Pd, Pt, Rh, or Ru;

(j″) at least one oxycarbide of at least one of Au, Co, Fe, Ir, Mn, Ni, Os, Pd, Pt, Rh, or Ru;

(k″) at least one oxyfluoride of at least one of Au, Co, Fe, Ir, Mn, Ni, Os, Pd, Pt, Rh, or Ru;

(l″) at least one oxynitride of at least one of Au, Co, Fe, Ir, Mn, Ni, Os, Pd, Pt, Rh, or Ru; or

(m″) at least one oxyboride of at least one of Au, Co, Fe, Ir, Mn, Ni, Os, Pd, Pt, Rh, or Ru.

### 16A

The article of either Exemplary Embodiment 14A or 15A, wherein the cathode catalyst layer comprises at least one of:

(a′″) at least one of elemental Al, carbon, Hf, Nb, Re, Si, Sn, Ta, Ti, W, or Zr;

(b′″) at least one alloy comprising at least one of Al, carbon, Hf, Nb, Re, Si, Sn, Ta, Ti, W, or Zr;

(c′″) at least one composite comprising at least one of Al, carbon, Hf, Nb, Re, Si, Sn, Ta, Ti, W, or Zr;

(d′″) at least one oxide of at least one of Al, Hf, Nb, Re, Si, Sn, Ta, Ti, W, or Zr;

(e′″) at least one organometallic complex of at least one of Al, Hf, Nb, Re, Si, Sn, Ta, Ti, W, or Zr;

(f′″) at least one carbide of at least one of Al, Hf, Nb, Re, Si, Sn, Ta, Ti, W, or Zr;

(g′″) at least one fluoride of at least one of Al, carbon, Hf, Nb, Re, Si, Sn, Ta, Ti, W, or Zr;

(h′″) at least one nitride of at least one of Al, carbon, Hf, Nb, Re, Si, Sn, Ta, Ti, W, or Zr;

(i′″) at least one oxycarbide of at least one of Al, Hf, Nb, Re, Si, Sn, Ta, Ti, W, or Zr;

(j′″) at least one oxyfluoride of at least one of Al, Hf, Nb, Re, Si, Sn, Ta, Ti, W, or Zr;

(k′″) at least one oxynitride of at least one of Al, carbon, Hf, Nb, Re, Si, Sn, Ta, Ti, W, or Zr;

(l′″) at least one boride of at least one of Al, carbon, Hf, Nb, Re, Si, Sn, Ta, Ti, W, or Zr; or

(m′″) at least one oxyboride of at least one of Al, Hf, Nb, Re, Si, Sn, Ta, Ti, W, or Zr.

### 17A

The article of any of Exemplary Embodiments 14A to 16A, wherein the cathode catalyst layer comprises nanostructured whiskers with the catalyst thereon.

### 18A

A fuel cell comprising an article of any of Exemplary Embodiments 9A to 17A.

### 19A

An electrolyzer comprising an article of any of Exemplary Embodiments 9A to 17A.

### 20A

A redox flow battery comprising an article of any of Exemplary Embodiments 1A to 8A.

### 1B

An article (e.g., a membrane electrode assembly or unitized electrode assembly) comprises, in order:
a first gas distribution layer having first and second opposed major surfaces optionally, a first gas dispersion layer having first and second opposed major surfaces;
an anode catalyst layer having first and second opposed major surface, the anode catalyst comprising a first catalyst;
a membrane;
a cathode catalyst layer having first and second opposed major surface, the cathode catalyst comprising a second catalyst;
optionally, a second gas dispersion layer having first and second opposed major surfaces; and
a second gas distribution layer having first and second opposed major surfaces, wherein at least one of (i.e., any one or any combinations):

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the second major surface of the first gas distribution layer has a central area, wherein the first major surface of the adhesive layer contacts at least the central area of the second major surface of the first gas distribution layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the second major surface of the first gas dispersion layer has a central area, wherein the first major surface of the adhesive layer contacts at least the central area of the second major surface of the first gas distribution layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the first major surface of the anode catalyst layer has a central area, wherein the second major surface of the adhesive layer contacts at least the central area of the first major surface of the anode catalyst layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the second major surface of the cathode catalyst layer has a central area, wherein the first major surface of the adhesive layer contacts at least the central area of the second major surface of the cathode catalyst layer;

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the first major surface of the second gas dispersion layer has a central area, wherein the second major surface of the adhesive layer contacts at least the central area of the first major surface of the second gas distribution layer; or

further comprising an (e.g., first, second, third, etc., as applicable) adhesive layer having first and second opposed major surfaces, wherein the adhesive layer comprises a porous network of adhesive including a continuous pore network extending between the first and second major surfaces of the adhesive layer, wherein the first major surface of the second gas distribution layer has a central area, wherein the second major surface of the adhesive layer contacts at least the central area of the first major surface of the second gas distribution layer.

### 2B

The article of Exemplary Embodiment 1B, wherein the porous network of the first adhesive layer comprises a plurality of second elongated adhesive elements.

### 3B

The article of Exemplary Embodiment 2B, wherein the first elongated adhesive elements have an aspect ratio in the range from 10:1 to 10000:1 (in some embodiments, an aspect ratio in the range from 10:1 to 1000:1, in the range from 10:1 to 100:1, or even in the range from 100:1 to 10000:1).

### 4B

The article of either Exemplary Embodiment 2B or 3B, wherein the first elongated adhesive elements have lengths in a range from 10 micrometers to 1 centimeter (in some embodiments, in the range from 10 micrometers to 100 micrometers, 25 micrometers to 1 centimeter, or even 100 micrometers to 1 centimeter) and at least one of diameters or widths in a range from 50 nm to 10000 nm (in some embodiments, in the range from 100 nm to 2000 nm, 200 nm to 1000 nm, or even 300 nm to 500 nm).

### 5B

The article of any of Exemplary Embodiments 2B to 4B, wherein the first elongated adhesive elements include fibers.

### 6B

The article of Exemplary Embodiments 2B to 5B, wherein the first adhesive comprises fluorinated thermoplastic (e.g., poly(tetrafluroethylene-co-vinylidene fluoride-co-hexafluporopropylene) or polyvinylidene fluoride) or hydrocarbon thermoplastic (e.g., acrylate and rubber, styrene).

### 7B

The article of Exemplary Embodiments 2B to 6B, wherein the first adhesive layer has porosity of at least 50 (in some embodiments, at least 55, 60, 65, 70, 75, 80, 90 or even at least 95; in some embodiments, in the range from 50 to 90, 60 to 80, or even 60 to 75) percent, based on the total volume of the first adhesive layer.

### 8B

The article of any Exemplary Embodiments 2B to 7B, wherein the first adhesive layer has a thickness of up to 10 micrometers (in some embodiments, up to 9 micrometers, 8 micrometers, 7 micrometers, 6 micrometers, 5 micrometers, 4 micrometers, 3 micrometers, 2 micrometers, or even up to 1 micrometer; in some embodiments, in a range from 0.5 micrometer to 10 micrometers, 0.5 micrometer to 5 micrometers, or even 0.5 micrometer to 2 micrometers).

### 9B

The article of any preceding B Exemplary Embodiment, wherein the anode catalyst layer comprises at least one of:

(a″) at least one of elemental Au, Co, Fe, Ir, Mn, Ni, Os, Pd, Pt, Rh, or Ru;

(b″) at least one alloy comprising at least one of Au, Co, Fe, Ir, Mn, Ni, Os, Pd, Pt, Rh, or Ru;

(c″) at least one composite comprising at least one of Au, Co, Fe, Ir, Mn, Ni, Os, Pd, Pt, Rh, or Ru;

(d″) at least one oxide of at least one of Au, Co, Fe, Ir, Mn, Ni, Os, Pd, Pt, Rh, or Ru;

(e″) at least one organometallic complex of at least one of Au, Co, Fe, Ir, Mn, Ni, Os, Pd, Pt, Rh, or Ru;

(f″) at least one carbide of at least one of Au, Co, Fe, Ir, Mn, Ni, Os, Pd, Pt, Rh, or Ru;

(g″) at least one fluoride of at least one of Au, Co, Fe, Ir, Mn, Ni, Os, Pd, Pt, Rh, or Ru;

(h″) at least one nitride of at least one of Au, Co, Fe, Ir, Mn, Ni, Os, Pd, Pt, Rh, or Ru;

(i″) at least one boride of at least one of Au, Co, Fe, Ir, Mn, Ni, Os, Pd, Pt, Rh, or Ru;

(j″) at least one oxycarbide of at least one of Au, Co, Fe, Ir, Mn, Ni, Os, Pd, Pt, Rh, or Ru;

(k″) at least one oxyfluoride of at least one of Au, Co, Fe, Ir, Mn, Ni, Os, Pd, Pt, Rh, or Ru;

(l″) at least one oxynitride of at least one of Au, Co, Fe, Ir, Mn, Ni, Os, Pd, Pt, Rh, or Ru; or

(m″) at least one oxyboride of at least one of Au, Co, Fe, Ir, Mn, Ni, Os, Pd, Pt, Rh, or Ru.

### 10B

The article of any preceding B Exemplary Embodiment, wherein the anode catalyst layer comprises at least one of:

(a′″) at least one of elemental Al, carbon, Hf, Nb, Re, Si, Sn, Ta, Ti, W, or Zr;

(b′″) at least one alloy comprising at least one of Al, carbon, Hf, Nb, Re, Si, Sn, Ta, Ti, W, or Zr;

(c′″) at least one composite comprising at least one of Al, carbon, Hf, Nb, Re, Si, Sn, Ta, Ti, W, or Zr;

(d′″) at least one oxide of at least one of Al, Hf, Nb, Re, Si, Sn, Ta, Ti, W, or Zr;

(e′″) at least one organometallic complex of at least one of Al, Hf, Nb, Re, Si, Sn, Ta, Ti, W, or Zr;

(f′″) at least one carbide of at least one of Al, Hf, Nb, Re, Si, Sn, Ta, Ti, W, or Zr;

(g′″) at least one fluoride of at least one of Al, carbon, Hf, Nb, Re, Si, Sn, Ta, Ti, W, or Zr;

(h′″) at least one nitride of at least one of Al, carbon, Hf, Nb, Re, Si, Sn, Ta, Ti, W, or Zr;

(i′″) at least one oxycarbide of at least one of Al, Hf, Nb, Re, Si, Sn, Ta, Ti, W, or Zr;

(j′″) at least one oxyfluoride of at least one of Al, Hf, Nb, Re, Si, Sn, Ta, Ti, W, or Zr;

(k′″) at least one oxynitride of at least one of Al, carbon, Hf, Nb, Re, Si, Sn, Ta, Ti, W, or Zr;

(l′″) at least one boride of at least one of Al, carbon, Hf, Nb, Re, Si, Sn, Ta, Ti, W, or Zr; or

(m′″) at least one oxyboride of at least one of Al, Hf, Nb, Re, Si, Sn, Ta, Ti, W, or Zr.

### 11B

The article of any preceding B Exemplary Embodiment, wherein the anode catalyst layer comprises nanostructured whiskers with the catalyst thereon.

### 12B

The article of any preceding B Exemplary Embodiment, wherein the cathode catalyst layer comprises at least one of:

(a″) at least one of elemental Au, Co, Fe, Ir, Mn, Ni, Os, Pd, Pt, Rh, or Ru;

(b″) at least one alloy comprising at least one of Au, Co, Fe, Ir, Mn, Ni, Os, Pd, Pt, Rh, or Ru;

(c″) at least one composite comprising at least one of Au, Co, Fe, Ir, Mn, Ni, Os, Pd, Pt, Rh, or Ru;

(d″) at least one oxide of at least one of Au, Co, Fe, Ir, Mn, Ni, Os, Pd, Pt, Rh, or Ru;

(e″) at least one organometallic complex of at least one of Au, Co, Fe, Ir, Mn, Ni, Os, Pd, Pt, Rh, or Ru;

(f″) at least one carbide of at least one of Au, Co, Fe, Ir, Mn, Ni, Os, Pd, Pt, Rh, or Ru;

(g″) at least one fluoride of at least one of Au, Co, Fe, Ir, Mn, Ni, Os, Pd, Pt, Rh, or Ru;

(h″) at least one nitride of at least one of Au, Co, Fe, Ir, Mn, Ni, Os, Pd, Pt, Rh, or Ru;

(i″) at least one boride of at least one of Au, Co, Fe, Ir, Mn, Ni, Os, Pd, Pt, Rh, or Ru;

(j″) at least one oxycarbide of at least one of Au, Co, Fe, Ir, Mn, Ni, Os, Pd, Pt, Rh, or Ru;

(k″) at least one oxyfluoride of at least one of Au, Co, Fe, Ir, Mn, Ni, Os, Pd, Pt, Rh, or Ru;

(l″) at least one oxynitride of at least one of Au, Co, Fe, Ir, Mn, Ni, Os, Pd, Pt, Rh, or Ru; or

(m″) at least one oxyboride of at least one of Au, Co, Fe, Ir, Mn, Ni, Os, Pd, Pt, Rh, or Ru.

### 13B

the article of any preceding b exemplary embodiment, wherein the cathode catalyst layer comprises at least one of:

(a′″) at least one of elemental Al, carbon, Hf, Nb, Re, Si, Sn, Ta, Ti, W, or Zr;

(b′″) at least one alloy comprising at least one of Al, carbon, Hf, Nb, Re, Si, Sn, Ta, Ti, W, or Zr;

(c′″) at least one composite comprising at least one of Al, carbon, Hf, Nb, Re, Si, Sn, Ta, Ti, W, or Zr;

(d′″) at least one oxide of at least one of Al, Hf, Nb, Re, Si, Sn, Ta, Ti, W, or Zr;

(e′″) at least one organometallic complex of at least one of Al, Hf, Nb, Re, Si, Sn, Ta, Ti, W, or Zr;

(f′″) at least one carbide of at least one of Al, Hf, Nb, Re, Si, Sn, Ta, Ti, W, or Zr;

(g′″) at least one fluoride of at least one of Al, carbon, Hf, Nb, Re, Si, Sn, Ta, Ti, W, or Zr;

(h′″) at least one nitride of at least one of Al, carbon, Hf, Nb, Re, Si, Sn, Ta, Ti, W, or Zr;

(i′″) at least one oxycarbide of at least one of Al, Hf, Nb, Re, Si, Sn, Ta, Ti, W, or Zr;

(j′″) at least one oxyfluoride of at least one of Al, Hf, Nb, Re, Si, Sn, Ta, Ti, W, or Zr;

(k′″) at least one oxynitride of at least one of Al, carbon, Hf, Nb, Re, Si, Sn, Ta, Ti, W, or Zr;

(l′″) at least one boride of at least one of Al, carbon, Hf, Nb, Re, Si, Sn, Ta, Ti, W, or Zr; or

(m′″) at least one oxyboride of at least one of Al, Hf, Nb, Re, Si, Sn, Ta, Ti, W, or Zr.

### 14B

the article of any preceding b exemplary embodiment, wherein the cathode catalyst layer comprises nanostructured whiskers with the catalyst thereon.

### 15B

A fuel cell comprising a membrane electrode assembly of any preceding B Exemplary Embodiment.

### 16B

An electrolyzer comprising a membrane electrode assembly of any of Exemplary Embodiments 1B to 14B.

### 17B

A redox flow battery comprising a membrane electrode assembly of any of Exemplary Embodiments 1B to 8B.

### 1C

A method of making the article of any preceding A Exemplary Embodiment, the method comprising:

providing a first gas distribution layer, a first gas dispersion layer, or a first electrode layer, as applicable, having first and second opposed major surfaces, wherein the first and second major surfaces of the first gas distribution layer, the first gas dispersion layer, or the first electrode layer, as applicable, each have an active area;

providing an adhesive composition; and

at least one of electrospinning or electrospraying the adhesive composition onto at least the active area of the second major surface of the first gas distribution layer, of the second major surface of the first gas dispersion layer, or of the first major surface of the first electrode layer, as applicable, to provide the adhesive layer.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

In the following examples, the electrospinning adhesive solution was loaded into a syringe fitted with a small bore syringe needle on the electrospinning device, as shown in FIG. 6. The deposition target was positioned 10 centimeters in front of the syringe needle of the electrospinning device and electrically grounded. The potential of the extruding syringe was set at 370 kV via a high voltage power supply.

### Materials

Polymer adhesive solution 1—A fluorinated terpolymer (obtained under the trade designation “THV 220” from 3M Company, St. Paul, Minn.) was dissolved to form a 15 wt. % solids solution in a solvent consisting of 60 wt. % of 2-butanone and 40 wt. % of dimethyl acetamide.

Polymer adhesive solution 2—A peroxide curable fluoroelastomer terpolymer (obtained under the trade designation “FPO-3730” from 3M Company) was dissolved to form a 15 wt. % solids solution in a solvent consisting of 60 wt. % of 2-butanone and 40 wt. % of dimethyl acetamide.

The deposition targets consisted of 7.07 centimeter by 7.07 centimeter sheets of carbon paper gas diffusion layer (GDL) having a gas dispersion layer (obtained under the trade designation “FREUDENBERG H2315 I2C3” from Freudenberg FCCT Se & Co. Kg, Weinheim, Germany).

An alternate deposition target consisted of 7.07 centimeter by 7.07 centimeter sheets of carbon paper gas diffusion layer (GDL) having a gas dispersion layer (obtained under the trade designation “2979 GDL” from 3M Company).

### Equipment

The electro-spinning equipment, as shown in FIG. 6, consisted of a high voltage power supply 640 (Model CZR 100R from Spellman of Hauppauge, N.Y.), and an infusion pump (Model AS40A from Baxter of Deerfield, Ill.) that was used to control the output of a syringe.

One disposable syringe (630) and two needles (620) were used per deposition, consisting of 3 mL capacity syringes (Model BD from Becton, Dickinson and Company, Franklin Lakes, N.J.); syringe needles (Model 16G BD from Becton, Dickinson and Company) for drawing the polymer solution into the syringe; and syringe needles (obtained under the trade designation “LUER-LOK; Model 27G BD” from Becton, Dickinson and Company) for extruding the electrospun nanofiber.

### Sample Preparation

### Example 1

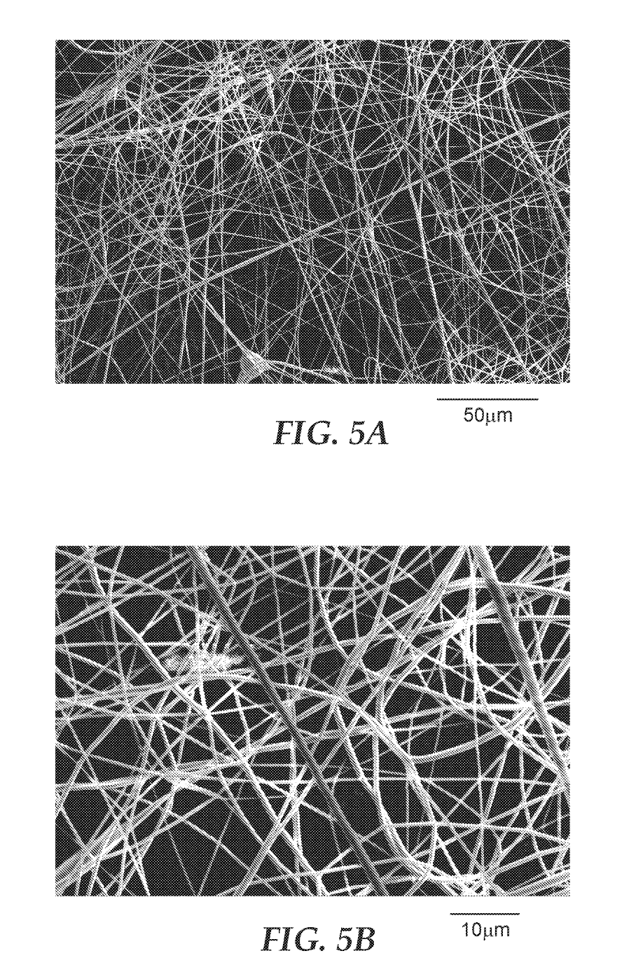

A solution of 15 wt. % fluorinated terpolymer (“THV 220”) in a mixture of 60 wt. % of 2-butanone and 40 wt. % of dimethyl acetamide was electrospun at a flow rate of 0.2 mL/min for 15 seconds onto the microporous (gas dispersion) layer side of an electrically grounded 7.07 centimeter by 7.07 centimeter (50 cm²) sample of a gas diffusion layer (“FREUDENBERG H2315 I2C3”) that was located 10 centimeters from the syringe needle tip. The needle potential was set at 370 kV via the high voltage power supply. Essentially 100% of central area or active area of the gas dispersion layer (“FREUDENBERG H2315 I2C3”) was covered with a porous layer of the electrospun nanofibers like the one shown in FIGS. 5A and 5B. The apparent total thickness of the porous nanofiber layer was about 2 micrometers. The average diameter of the electrospun nanofibers was about 300 nanometers. Before-and-after weighing of three samples determined that the amount of polymer deposited on the sample substrates in 15 seconds varied from 0.0081 to 0.0085 gram, with an average of 0.0083 gram of polymer deposited. For a polymer density of 1.78 gram/cm³, this loading is enough to cover the entire 50 cm² sample to a depth of about 930 nanometers, or over three times the average diameter of the nanofibers.

### Example 2

The procedure of Example 1 was repeated, except that polymer was deposited on the (gas dispersion layer side of the) gas diffusion layer (“FREUDENBERG H2315 I2C3”) for 30 seconds. The average of three 30 second depositions on gas distribution layer samples was 0.0186 gram of polymer deposited.

### Example 3

The procedure of Example 1 was repeated, except that polymer was deposited on the gas diffusion layer (“FREUDENBERG H2315 12C3”) for 60 seconds. The average of three 60 second depositions on gas diffusion layer samples was 0.0388 gram of polymer deposited.

### Example 4

A solution of 15 wt. % peroxide curable fluoroelastomer terpolymer (“FPO-3730”) in a mixture of 60 wt. % of 2-butanone and 40 wt. % of dimethyl acetamide was electrospun at a flow rate of 0.1 mL/min for 60 seconds onto the microporous layer side of an electrically grounded, 7.07 centimeter by 7.07 centimeter sample of gas diffusion layer (“FREUDENBERG H2315 I2C3”) that was located 10 centimeters from the syringe needle tip. The needle potential was set at 370 kV via the high voltage power supply.

### Example 5

A sample was prepared as in Example 1, except that the fluorinated terpolymer (“THV 220”) was deposited for 120 seconds onto the microporous gas dispersion layer side of a 50 cm² sample of gas diffusion layer material (“2979 GDL”). Essentially 100% of central area or active area of the gas dispersion layer side of the gas diffusion layer (“2979 GDL”) was covered with a porous layer of the electrospun nanofibers. Scanning electron microscope (SEM) images of this sample are shown in FIGS. 5A and 5B. FIG. 5A shows a top view of the electrospun nanofiber adhesive layer on the gas diffusion layer (“2979 GDL”) at a magnification of 500×. FIG. 5B shows another top view SEM image of the same sample, at a magnification of 1700×.

### Sample Testing in a Polymer Electrolyte Membrane Hydrogen Fuel Cell

### Preparation of Membrane Electrode Assemblies

The samples were made into membrane electrode assemblies (MEAs) by bonding each gas diffusion layer (“FREUDENBERG H2315 I2C3”) having the nanofiber adhesive on it to a catalyst coated membrane (CCM) in a hot press (obtained under the trade designation “CARVER”; Model 2518 from Fred S. Carver Inc., Wabash, Ind.). The hot press was set at 280° F. (138° C.) and 3000 pounds (13300 Newtons) of force on a sample active area of 50 cm² for 10 minutes. The sample was surrounded by a gasket that set a hard stop of 20% compression of the gas diffusion layer material.

The catalyst coated membranes were formed from perfluorosulfonic acid based proton-conducting polymer electrolyte membranes laminated to anode and cathode catalyst layers with a roll laminator set to 285° F. (141° C.) and about 800 pounds (3560 Newtons) of force per linear inch (2.54 centimeters). The anode layer was coated on a separate liner with 0.05 mg/cm² of carbon-supported platinum catalyst and the cathode layer was coated with 0.25 mg/cm² carbon-supported platinum alloy catalyst on a separate liner. The composite catalyst coated membrane is obtainable under the designation “3M COOL AIR CCM” from 3M Company, St. Paul, Minn.

### Adhesion Testing

Membrane electrode assemblies prepared using electrospun nanofiber coated gas diffusion layers, as described in Examples 1-3, above, were tested to measure the adhesion of the electrospun nanofibers by bonding them by means of heat and pressure, as described in the “Preparation of membrane electrode assemblies” section above, then subjecting them to standard 180 degree peel tests according to ASTM D3330 (2007), the disclosure of which is incorporated herein by reference. For these measurements, nanofiber coated gas diffusion layers were bonded to only one side of the catalyst coated membrane, either the cathode side or the anode side. The gas diffusion layer was then adhered to a flat surface and the catalyst coated membrane was pulled off at an angle of 180 degrees, as described in Test A of the cited ASTM standard. FIG. 7 shows the results of these tests depicted in a bar chart. Bar 701 is the peel strength for the case where the adhesive was applied to the anode side gas diffusion layer for 60 seconds and bar 702 for the case where the adhesive was applied to the cathode side gas diffusion layer for 60 seconds. Bar 711 represents the data for the adhesive when applied to anode side gas diffusion layer for 30 seconds and bar 712 represents the data for the adhesive when applied to the cathode side gas diffusion layer for 30 seconds. Bar 721 represents the data for the adhesive when applied to anode side gas diffusion layer for 15 seconds and bar 722 represents the data for the adhesive when applied to the cathode side gas diffusion layer for 15 seconds. Each bar in the figure represents the peel strength for the average of 3 samples, in grams/cm.

### Fuel Cell Testing

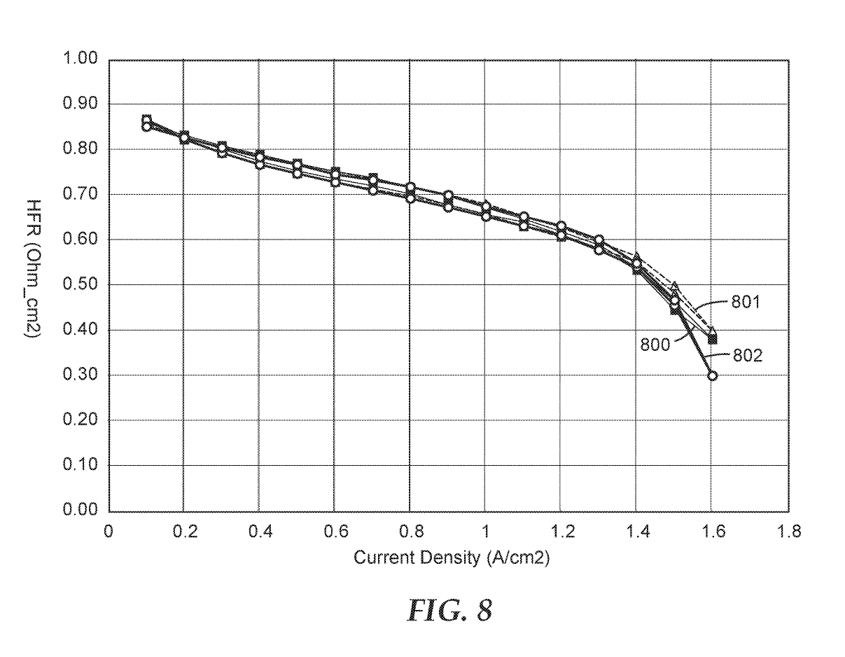

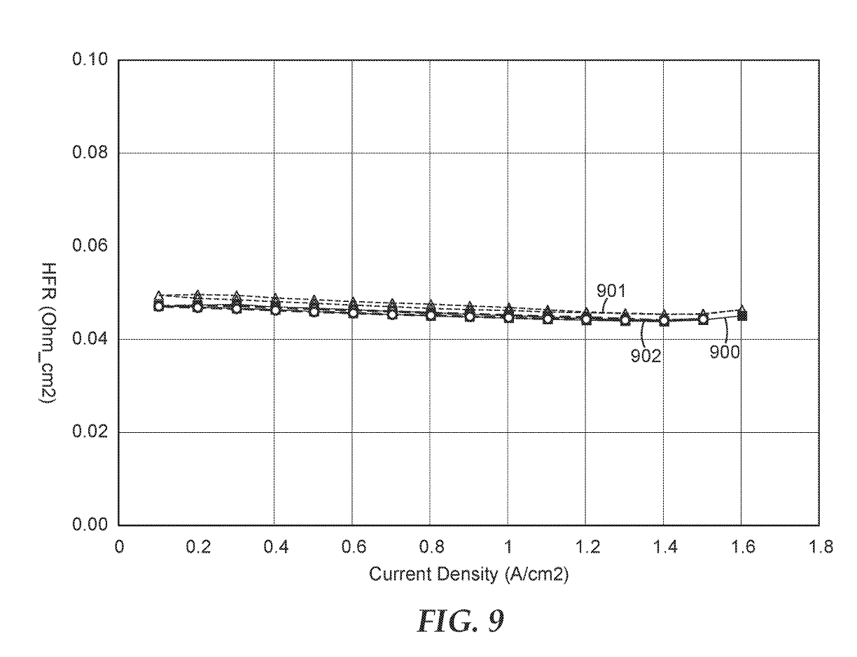

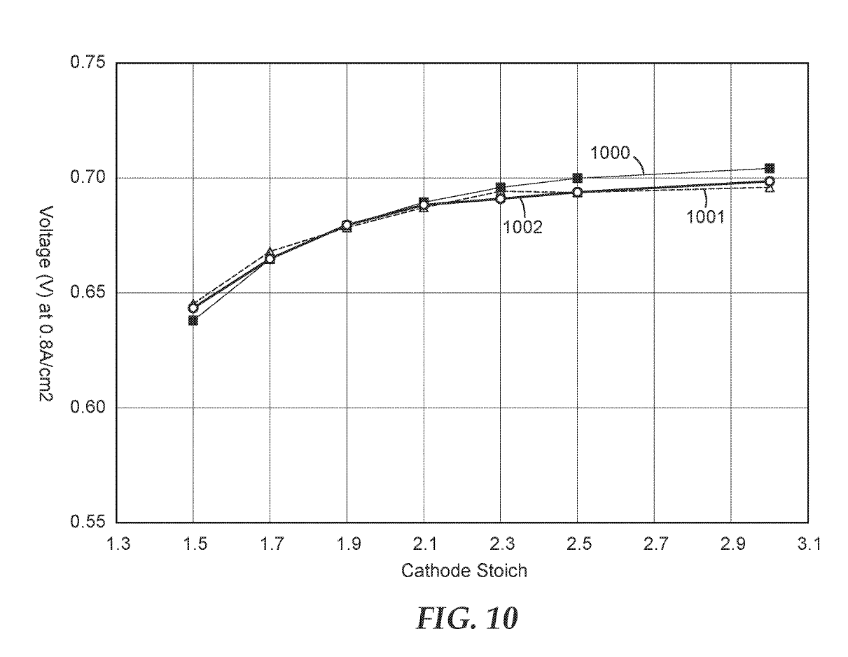

Fuel cell testing was conducted to determine the effect that the adhesive had on performance. Standard fuel cell initial performance tests were completed. These included: galvano-dynamic scanning (GDS) polarization performance scans in FIG. 8; in FIG. 9, high frequency resistance measurements taken during the GDS scans; and in FIG. 10, sensitivity to reduction in cathode air stoichiometry.

The membrane electrode assemblies containing the adhesive-loaded gas diffusion layer samples were mounted in a fuel cell test station (obtained from Fuel Cell Technologies, Albuquerque, N. Mex.). The electrodes of the fuel cell test station were connected to a multistat, (Model 480, from Solartron, Farnborough, Hampshire, England) for high frequency resistance (AC impedance) measurements. The cell compression was 20%. For the galvano-dynamic scans shown in FIG. 5, the fuel cell was operated at a cell temperature of 70° C. with fully humidified hydrogen supplied to the anode and fully humidified air supplied to the cathode. Both hydrogen and air were supplied at atmospheric pressure with the anode stoichiometry set at 1.4 (indicating that the ratio of reactant provided (H₂) to that needed for the electrochemical reaction of interest was 1.4) and the cathode stoichiometry set at 2.5 (indicating that the ratio of O₂ (in air) provided to the amount needed was 2.5). Three samples were tested, as follows:

1) a control membrane electrode assembly made by placing the microporous layer side of a gas diffusion layer (“FREUDENBERG H2315 12C3”) adjacent to the catalyst coated membrane with no adhesive between them, as is typically the case when testing catalyst coated membranes;

2) a membrane electrode assembly in which nanofibers of fluorinated terpolymer (“THV 220”) were electrospun for 60 seconds onto the microporous layer side of a gas diffusion layer (“FREUDENBERG H2315 12C3”) made as in Example 3 above, and this adhesive coated side was placed adjacent to the catalyst coated membrane, with no additional bonding heat or pressure applied to the membrane electrode assembly other than the 20% cell compression during cell assembly; and

3) a membrane electrode assembly in which nanofibers of fluorinated terpolymer (“THV 220”) were electrospun for 60 seconds onto the microporous layer side of a gas diffusion layer (“FREUDENBERG H2315 12C3”) made as in Example 3 above; this adhesive coated side was placed adjacent to the catalyst coated membrane, and the membrane electrode assembly was then thermally bonded by subjecting the membrane electrode assembly to 3000 pounds (13300 Newtons) of force and a temperature of 280° F. (138° C.) for 10 minutes before incorporating the membrane electrode assembly into the test cell.

In the galvano-dynamic scans shown in FIG. 8, the sample performance of the membrane electrode assembly bonded using the adhesive nanofiber layer 802 was compared to the performance of two control samples consisting of the same type of catalyst coated membrane and gas distribution layer materials assembled in the cell without adhesive 800 and without bonding at elevated temperature or pressure 801. For the galvano-dynamic scan, the test cell current density was started initially at a low value of ˜0.1 A/cm², then it was stepped up to a high current density of ˜1.6 A/cm², then stepped back down again to 0.1 A/cm², while monitoring the cell voltage. The cell voltage values reported are the average over a period of 60 seconds at each point. The humidified input hydrogen and oxygen streams and the cell were all maintained at 70° C. The gas pressures were controlled to atmospheric pressure. The cell stoichiometry was 1.4 on the anode and 2.5 on the cathode.

The high frequency resistance of the cell was also measured during these scans, and the results are shown in FIG. 9. The cell test conditions are the same as the galvano-dynamic scan. The sample high frequency resistance of the membrane electrode assembly bonded using the adhesive nanofiber layer 902 was compared to the performance of two control samples consisting of the same type of catalyst coated membrane and gas distribution layer materials assembled in the cell without adhesive 900 and without bonding at elevated temperature or pressure 901.

After the tests shown in FIGS. 8 and 9, the samples and control were subjected to a cathode air stoichiometry test in the same fuel cell test station, as shown in FIG. 10. The fuel cell was operated at a constant current density of 0.8 A/cm², and the cell voltage was measured as the cathode air stoichiometry was varied. The cathode stoichiometric ratio was started at 3.0, and the average voltage over a period of 6 minutes was recorded. The stoichiometric ratio was then stepped down and the voltage at another stoichiometry point was measured and averaged over 6 minutes. The process was repeated down to a cathode air stoichiometric ratio of 1.5. The sample performance of the membrane electrode assembly bonded using the adhesive nanofiber layer 1002 was compared to the performance of two control samples consisting of the same type of catalyst coated membrane and gas distribution layer materials assembled in the cell without adhesive 1000 and without bonding at elevated temperature or pressure 1001.

Foreseeable modifications and alterations of this disclosure will be apparent to those skilled in the art without departing from the scope and spirit of this invention. This invention should not be restricted to the embodiments that are set forth in this application for illustrative purposes.

1. An article comprising a first gas distribution layer, a first gas dispersion layer, or a first electrode layer having first and second opposed major surfaces and a first adhesive layer having first and second opposed major surfaces, wherein the second major surface of the first gas distribution layer, the second major surface of the first gas dispersion layer, or the first major surface of the first electrode layer, as applicable, has a central area, wherein the first major surface of the first adhesive layer contacts at least the central area of the second major surface of the first gas distribution layer, the first major surface of the first adhesive layer contacts at least the central area of the second major surface of the first gas dispersion layer, or the second major surface of the first adhesive layer contacts at least the central area of the first major surface of the first electrode layer, as applicable, and wherein the first adhesive layer comprises a porous network of first adhesive including a continuous pore network extending between the first and second major surfaces of the first adhesive layer.

2. The article of claim 1, wherein the porous network of first adhesive comprises a plurality of first elongated adhesive elements.

3. The article of claim 1, wherein the first adhesive comprises fluorinated thermoplastic.

4. The article of claim 1, wherein the first adhesive layer has porosity of at least 50 percent, based on the total volume of the first adhesive layer.

5. The article of claim 1 wherein the first adhesive layer has a thickness up to 10 micrometers.

6. A fuel cell comprising an article of claim 1.

7. An electrolyzer comprising an article of claim 1.

8. A redox flow battery comprising an article of claim 1.

9. A method of making the article claim 1, the method comprising:
providing a first gas distribution layer, a first gas dispersion layer, or a first electrode layer, as applicable, having first and second opposed major surfaces, wherein the first and second major surfaces of the first gas distribution layer, the first gas dispersion layer, or the first electrode layer, as applicable, each have an active area;
providing an adhesive composition; and
at least one of electrospinning or electrospraying the adhesive composition onto at least the active area of the second major surface of the first gas distribution layer, of the second major surface of the first gas dispersion layer, or of the first major surface of the first electrode layer, as applicable, to provide the adhesive layer.
